(19) United States
(12) Patent Application Publication
(10) Pub. No.: US 2019/0374060 A1
(43) Pub. Date: Dec. 12, 2019

(54) AUTOMATED SOUS-VIDE COOKING DEVICE

(71) Applicant: Botpot, Inc., North Salt Lake, UT (US)

(72) Inventors: Britton Winterrose, Salt Lake City, UT (US); Andrzej Forys, Salt Lake City, UT (US)

(73) Assignee: Botpot, Inc., North Salt Lake, UT (US)

(21) Appl. No.: 16/479,062

(22) PCT Filed: Jan. 19, 2018
(86) PCT No.: PCT/US2018/014491

§ 371 Date: Jul. 18, 2019

Related U.S. Application Data
(60) Provisional application No. 62/448,341, filed on Jan. 19, 2017.

(51) Int. Cl. A47J 27/18; A47J 27/10; A47J 36/32; A23L 5/10

(52) U.S. Cl. CPC A47J 27/18; A47J 27/10; A23V 2002/00; A23L 5/13; A47J 36/321

(57) ABSTRACT

A sous-vide cooking device is an integrated appliance that includes a refrigerated food storage compartment, a cooking tank, a heating feature to heat the liquid held in the cooking tank, a refrigeration device to maintain a refrigerated temperature in the food storage compartment, and a controller to provide automated operation of at least some functionality of the sous-vide cooking device. The cooking device may automatically dispense a food item from the food storage compartment into the cooking tank based on a pre-determined schedule. The appliance may be sized sufficiently small to fit on a typical kitchen counter in a residential home.

### TECHNICAL FIELD

The present disclosure is directed to sous-vide cooking devices and methods, and related devices and methods for automated sous-vide cooking.

### BACKGROUND

Sous-vide is a method of cooking in which food is sealed in a vacuum-sealed plastic pouch, then placed in a water bath or in a temperature-controlled steam environment for longer than normal cooking times (usually 1 to 6 hours, and up to 48 or more hours in some select cases) at an accurately regulated temperature much lower than normal normally used for cooking, typically around 130° F. to 140° F. (55° C. to 60° C.) for meat and higher for vegetables. The intent is to cook the item evenly, insuring that the inside is properly cooked without overcooking the outside, and retaining moisture.

The sous-vide method was first used in the early 1800's, and then rediscovered by American and French engineers in the mid-1960's and developed into an industrial food preservation method. Since then, a number of restaurants and chefs have furthered the development of sous-vide cooking, and the method has become mainstream in recent history.

A number of challenges exist associated with sous-vide cooking, particularly related to the timing of putting the food item in the heated water bath so that the completion of cooking the food item occurs at the desired time. Because of the significantly longer duration of cooking that is needed, the food item must be placed in the heated water bath at times when many people are typically at their place of employment or involved in other activities that take them away from the sous-vide cooking device. Another challenge relates to the different amounts of time that are required for cooking different types of food items, such as meat versus vegetables, etc. Another challenge relates to the size and shape of typical sous-vide cookers, which are voluminous, cumbersome, and difficult to manage in a home kitchen, thus making it less practical for individuals to purchase and maintain a sous-vide cooker in their home.

Opportunities exist for improvements in devices and methods for sous-vide cooking.

### DISCLOSURE OF THE INVENTION

One aspect of the present disclosure relates to a cooking device that includes a food storage compartment configured to retain at least one food item, a cooking tank configured to retain a volume of liquid, at least one door interposed between the food storage compartment and the cooking tank, an actuator, and a programmable controller. The actuator is operable to control movement of the at least one door between open and closed positions, wherein the at least one food item automatically dispenses from the food storage compartment to the cooking tank when the at least door is in the open position. The controller is operable to control operation of the actuator based on one or more user inputs.

The food storage compartment may be positioned vertically above the cooking tank. The food storage compartment may be movable from a first position vertically above the cooking tank to a second position moved laterally relative to the cooking tank. The food storage compartment may be refrigerated. The at least one door may be insulated. The cooking device may further include a heater system configured to circulate heated liquid to the cooking tank. The cooking device may further include a refrigerator system configured to circulate cooled fluids to the food storage compartment. The food storage compartment may include at least two food chambers configured to retain separate food items. The at least one door may include a separate door for each of the at least two food chambers. The at least one door may include first and second doors.

The controller may have remote control capabilities. The controller may operate to control a temperature of the volume of liquid and a temperature inside the food storage compartment. The cooking device may include a plurality of temperature sensors operable to sense a temperature of the volume of liquid and a temperature inside the food storage compartment. The cooking device may include a user interface operable to receive user inputs. The cooking device may include a scanner operable to detect the at least one food item inside the food storage compartment. The heater system may include a heater and at least one pump configured to transfer the volume of liquid between the heater and the cooking tank. The refrigerator system may include a heat pump and at least one fan.

The cooking device may include a secondary tank, wherein the food storage compartment includes a plurality of compartments each sized to hold a separate food item, the at least one door includes a plurality of doors associated with the plurality of compartments, and the plurality of doors are operable by the actuator to dispense food items from the plurality of compartments to at least one of the cooking tank and the secondary tank. The cooking device may include an alarm system configured to provide a notification of a status of the cooking device. The status may include at least one of an on/off state of the cooking device, a temperature of a liquid stored in the cooking tank, a temperature inside the food storage compartment, and a cooking time for the food item positioned in the cooking tank. The at least one door may be biased into the closed position by a biasing force, the actuator may operate to move the at least one door from the closed position to the open position against the biasing force, and the at least one door may move from the open position to the closed position by releasing the actuator.

The cooking device may include a housing, wherein the food storage compartment, cooking tank, at least one door, actuator, and programmable controller are positioned within the housing and movable as a single unit. The food storage compartment may include a lid movable between open and closed positions to provide access to an interior of the food storage compartment. The food storage compartment may include an interior housing and an exterior housing, the interior housing including at least one bay sized to retain the food item, and a space provided between the interior and exterior housings may be filled with an insulating material. The refrigerator system may include a compressed gas, Peltier style refrigeration device. The cooking device may include a depth sensor operable to determine a depth of liquid stored in the cooking tank.

Another aspect of the present disclosure relates to a method of cooking a food article. The method includes providing a cooking device comprising a food storage compartment, a cooking tank, at least one door interposed between the food storage compartment and the cooking tank, an actuator, and a heater assembly. The method also includes operating the heater assembly to control a temperature of liquid stored in the cooking tank, and operating the actuator to control movement of the at least one door between a closed position and an open position to dispense a food item from the food storage compartment to the cooking tank.

The cooking device may also include a controller, wherein the controller is programmable based on one or more user inputs, and the controller provides instructions to operate the heater assembly and the actuator. The cooking device may include a refrigerator system, and the method may further include operating the refrigerator system to control a temperature inside the food storage compartment. Operating the heater assembly and operating the actuator automatically may occur based on a pre-programmed schedule. The food storage compartment may be positioned vertically above the cooking tank, and operating the actuator to control movement of the at least one door between a closed position and an open position may permit the food item to fall by gravity force from the food storage compartment to the cooking tank.

The foregoing and other features, utilities, and advantages of the subject matter described herein will be apparent from the following more particular description of certain embodiments as illustrated in the accompanying drawings.

### BRIEF DESCRIPTION OF THE DRAWINGS

FIG. 1 is a top perspective view of an example sous-vide cooking device in accordance with the present disclosure.

FIG. 2A is a rear perspective view of the sous-vide cooking device shown in FIG. 1.

FIG. 2B is another rear perspective view of the sous-vide cooking device shown in FIG. 1 with a food storage compartment moved laterally relative to a cooking tank of the cooking device.

FIG. 3A is a top view of the sous-vide cooking device shown in FIG. 1.

FIG. 3B is a cross-sectional view of the sous-vide cooking device shown in FIG. 3A taken along cross-section indicators 3B-3B.

FIG. 4 is an exploded perspective view of the cooking device shown in FIG. 1.

FIG. 5 is an exploded side view of the cooking device shown in FIG. 1.

FIG. 6 is a front perspective view of another example sous-vide cooking device in accordance with the present disclosure.

FIG. 7 is a rear perspective view of the sous-vide cooking device shown in FIG. 6.

FIG. 8 is another front perspective view of the sous-vide cooking device shown in FIG. 6.

FIG. 9 is another front perspective view of the sous-vide cooking device shown in FIG. 6 with a top lid in an open position.

FIGS. 10A and 10B illustrate an oven appliance with a sous-vide cooking device integrated therein.

FIGS. 11A-11E illustrate several refrigerator appliance embodiments with sous-vide cooking devices integrated therein.

FIGS. 12A-12F illustrate an example sous-vide cooking device integrated into a cabinet structure.

FIGS. 13A-13C illustrate a toaster oven appliance with a sous-vide cooking device integrated therein.

FIGS. 14-17 illustrate example networks of appliances that include sous-vide cooking devices.

FIGS. 18-27 illustrate flow diagrams related to functionality of a sous-vide cooking device and/or system or network that include sous-vide cooking devices and related methods of operation.

FIG. 28 shows a diagram of a system in accordance with various aspects of this disclosure.

### BEST MODE(S) FOR CARRYING OUT THE INVENTION

Reference is made in the following to a number of illustrative embodiments of the subject matter described herein. The following embodiments illustrate only a few selected embodiments that may include the various features, characteristics, and advantages of the subject matter as presently described. Accordingly, the following embodiments should not be considered as being comprehensive of all of the possible embodiments. Also, features and characteristics of one embodiment may and should be interpreted to equally apply to other embodiments or be used in combination with any number of other features from the various embodiments to provide further additional embodiments, which may describe subject matter having a scope that varies (e.g., broader, etc.) from the particular embodiments explained below. Accordingly, any combination of any of the subject matter described herein is contemplated.

The present disclosure generally relates to sous-vide cooking devices and related methods of cooking using various embodiments of a sous-vide cooking device. Other aspects of the present disclosure related to integration of one or more sous-vide cooking devices or components thereof as part of a network that provides remote control and/or integrated operation of multiple appliances, including one or more sous-vide cooking devices.

In at least some embodiments, the sous-vide cooking device is an integrated appliance that includes a refrigerated food storage compartment, a cooking tank, a heating feature to heat the liquid held in the cooking tank, a refrigeration device to maintain a refrigerated temperature in the food storage compartment, and a controller to provide automated operation of at least some functionality of the sous-vide cooking device. The appliance may be sized sufficiently small to fit on a typical kitchen counter in a residential home. In other embodiments, the appliance may be substantially larger in size and configured for use in, for example, a restaurant or a commercial kitchen.

One embodiment of an automated sous-vide cooking device includes a fully-refrigerated upper compartment capable of holding multiple food selections in separate bays. The food items are sealed in vacuumed bags such as a reusable food-grade silicone material or a food-grade polyethylene/nylon polymer. A lid to the refrigerated compartment may be opened to reveal all of the bays and allow a user to load each bay with one or more food items according to their wishes. The refrigerated compartment bays are separated from a cooking tank with one or more doors. Typically, the cooking tank is positioned vertically below the refrigerated compartment bays, so that the food items may move automatically by gravity forces into the cooking tank when the doors are opened. The doors may have a trap-door configuration such that upon receipt of a signal from a controller, the door associated with a bay where a user's food selection is opened and the food item drops into the cooking tank.

Once inside the cooking tank, the food item resides in the heated liquid held in the cooking tank for a predetermined amount of time until cooking is complete. The temperature of the liquid is monitored and maintained at a predetermined level. In one embodiment, the liquid is moved into and out of the cooking tank as a part of maintaining the temperature of the liquid. For example, the liquid may be drawn out of the tank (e.g., by pumping), heated, and returned to the tank (e.g., by pumping) in order to increase a temperature of the liquid held the cooking tank.

The packaging of the food items may include identification information that can be read or identified automatically when the food article is positioned in the cooking device. For example, the refrigerated compartment or the cooking tank may include a passive RFID module or automatic QR code reader that gathers information from the food packaging. The cooking device may automatically adjust temperatures, operate doors, provide notifications, etc., based on the type of food item and other considerations such as various operations of the cooking device.

The cooking device may be networked via, for example, a Wi Fi or other wireless technology and controlled via, for example, a remote computing device such as user's smart phone, a web-accessible interface, or the like. This networking functionality and remote-control capability provides the user with the option of controlling the cooking device from any location, receive notifications regarding the status of a food item being cooked, etc.

The cooking device may be relatively compact in size such as, for example, within a size range of 6 inches to about 20 inches in width, about 10 inches to about 30 inches in height, and a length in the range of about 10 inches to about 40 inches. In one embodiment, the sous-vide cooking device has dimensions of about 8 inches in width, about 14 inches in height, and about 16 inches in length. Many other sizes, shapes, and configurations may be possible for the cooking device, including separating various components of the cooking device into different structures and/or in different locations.

Generally, the various sous-vide cooking devices disclosed herein and their related methods of operation provide the ability for a user to load food items into the refrigerated compartment of the cooking device, leave the cooking device unattended for extended periods of time, decide hours or days later what food items to eat, and control the cooking device remotely such that the selected food items are cooked by a predetermined time without the user present to load or supervise the cooking device.

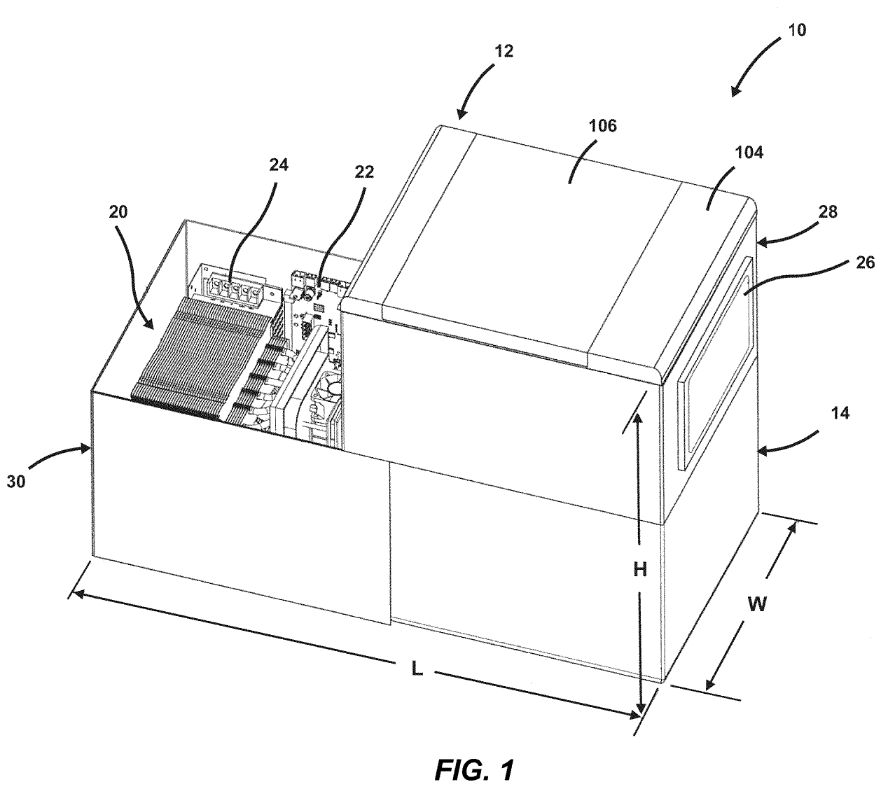

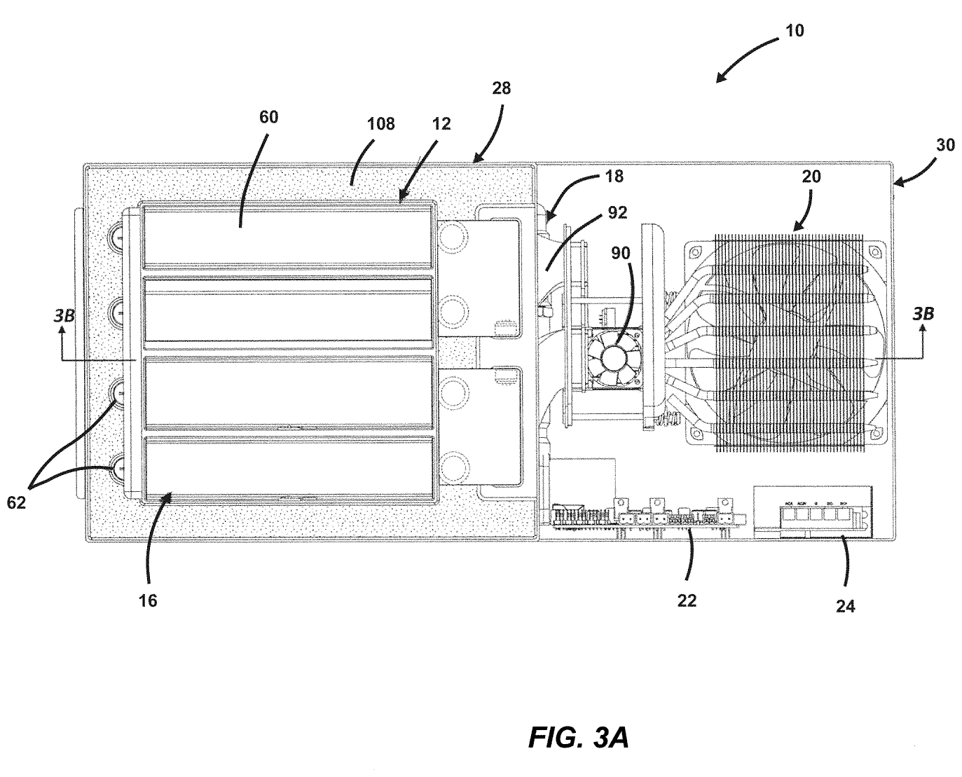

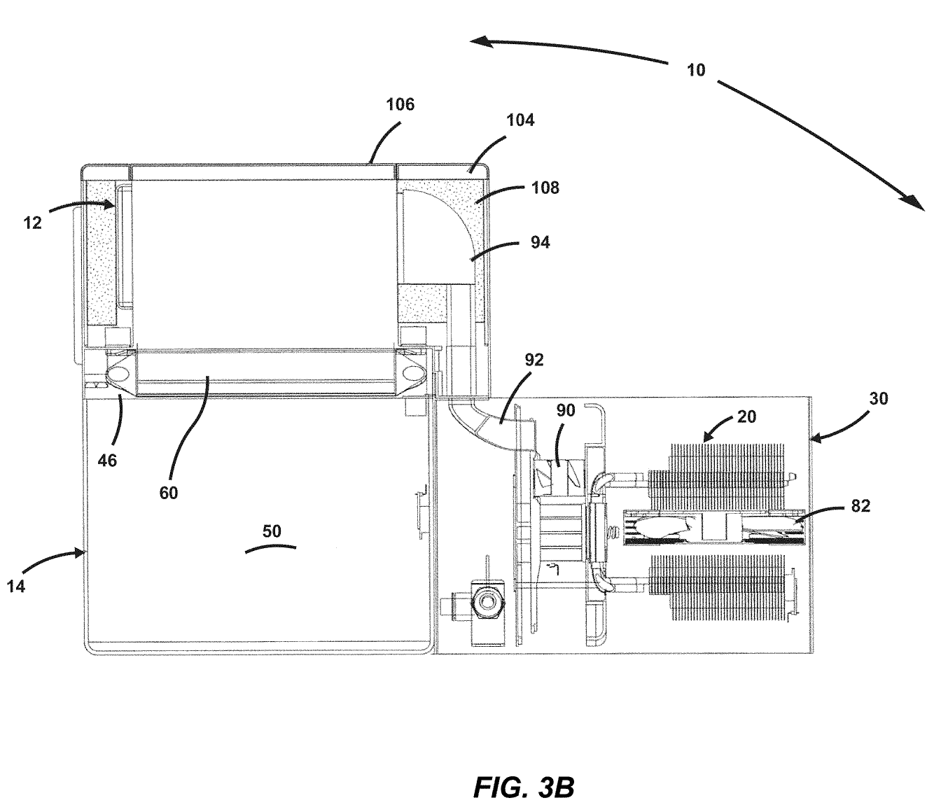

Referring now to FIGS. 1-5, an example sous-vide cooking device 10 is shown and described. The cooking device 10 includes a food storage compartment 12, a cooking tank 14, a door assembly 16 (see FIG. 3A), a heater assembly 18, a refrigerator assembly 20, a controller 22, a power supply 24, a user interface 26, upper and lower housing assemblies 28, 30, and a rail assembly 32. The combination of components shown in FIGS. 1-5 may have a relatively compact size as described above. FIG. 1 shows the width W, height H, and length L dimensions for the cooking device 10. Many other designs and configurations are possible for the sous-vide cooking device features and functionality described herein. The embodiments illustrated herein should not be limiting as to the appearance, relative positioning, or functionality of any or all of the components disclosed herein.

While the cooking devices disclosed herein typically include electronic components including, for example, microprocessors, controllers, transceivers, etc. to provide a variety of automated and wireless/remote controlled functionality, it is possible to use certain components or combinations of components of the cooking devices disclosed herein to provide new and nonobvious combinations that do not include such electronic, automated and/or wireless/remote control functionality. For example, some aspects of the refrigerator assembly, heater assembly, door assembly, and other features, when used in the environment of sous-vide cooking devices may individually or in some combination provide certain advantages not previously anticipated by or found obvious in view of the prior art. For example, the use of a dedicated refrigerated food storage compartment to store food items prior to cooking as part of a sous-vide cooking device by itself may be a major step forward in this technical field.

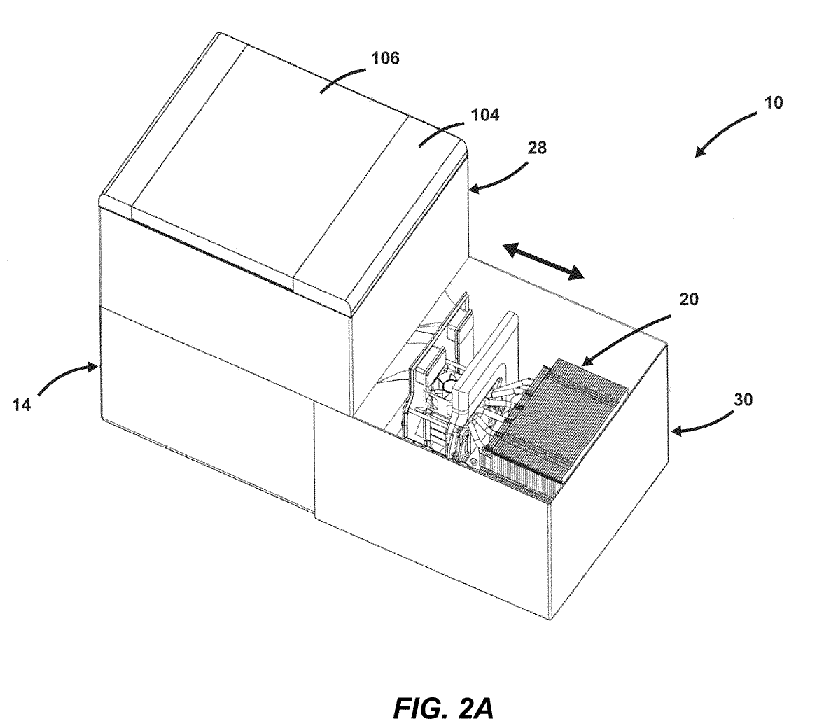

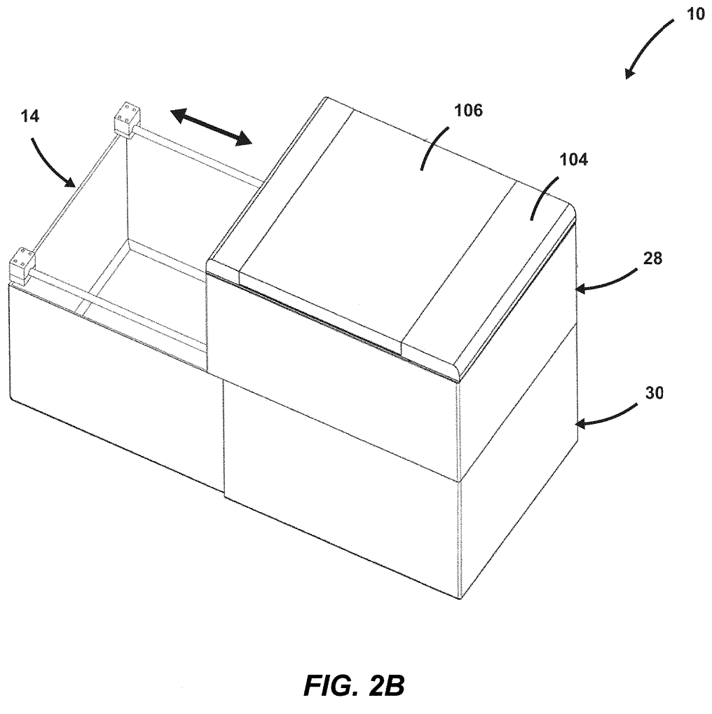

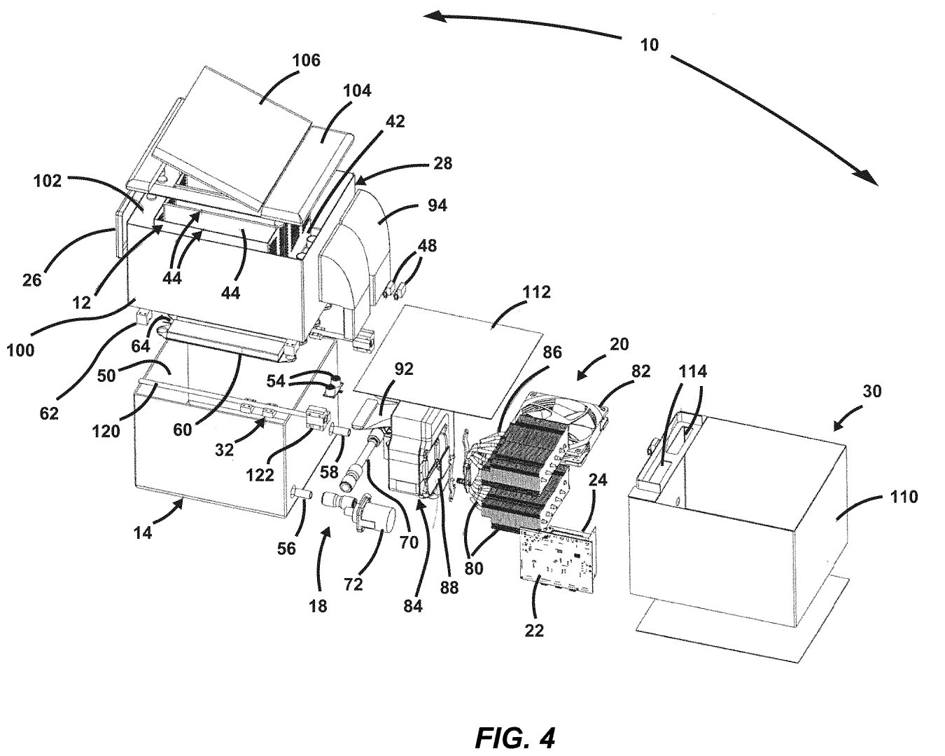

The refrigerated food storage compartment 12 is shown and describe in greater details with greater detail with reference to FIGS. 3A-5. The food storage compartment 12 includes at least one bay 40, although a plurality of bays 40 may be used for a single food storage compartment 12. Each of the bays 40 may include at least one rear vent 42 for the input and removal of refrigerated air, a top opening 44, a bottom opening 46, and a temperature sensor 48 (see FIG. 4). The food storage compartment 12 generally is positioned vertically above the cooking tank 14. In some embodiments, the food storage compartment 12 may be moveable relative to the cooking tank 14 to provide access to an interior of the cooking tank 14. For example, FIG. 2A shows the food storage compartment 12 and related upper housing assembly 28 in a first operation position positioned directly vertically above the cooking tank 14 so that the food storage compartment 12 can dispense a food item, which is stored in the bays 40, directly into the cooking tank 14 by gravity forces. FIG. 2B shows the food storage compartment 12 and upper housing assembly 28 in a second, removed position in which the cooking tank 14 is accessible through a top opening of the cooking tank 14. The food storage compartment 12 is shown in FIG. 2B positioned vertically above the lower housing assembly 30.

In the position shown in FIG. 2B, the food storage compartment 12 is disconnected from the refrigerator assembly 20. As such, the second position shown in FIG. 2B is typically a temporary position that is achieved only for the purpose of accessing the cooking tank 14 and not while food items are being stored long-term in the food storage compartment 12. Other embodiments are possible for providing access to the cooking tank interior 14 such as, for example, moving the food storage compartment 12 laterally rather than in a rearward direction, moving the storage compartment 12 vertically, providing a separate door or access point into the cooking tank 14 without moving the food storage compartment 12 relative to the cooking tank 14, or disconnecting the food storage compartment 12 completely from the cooking tank 14.

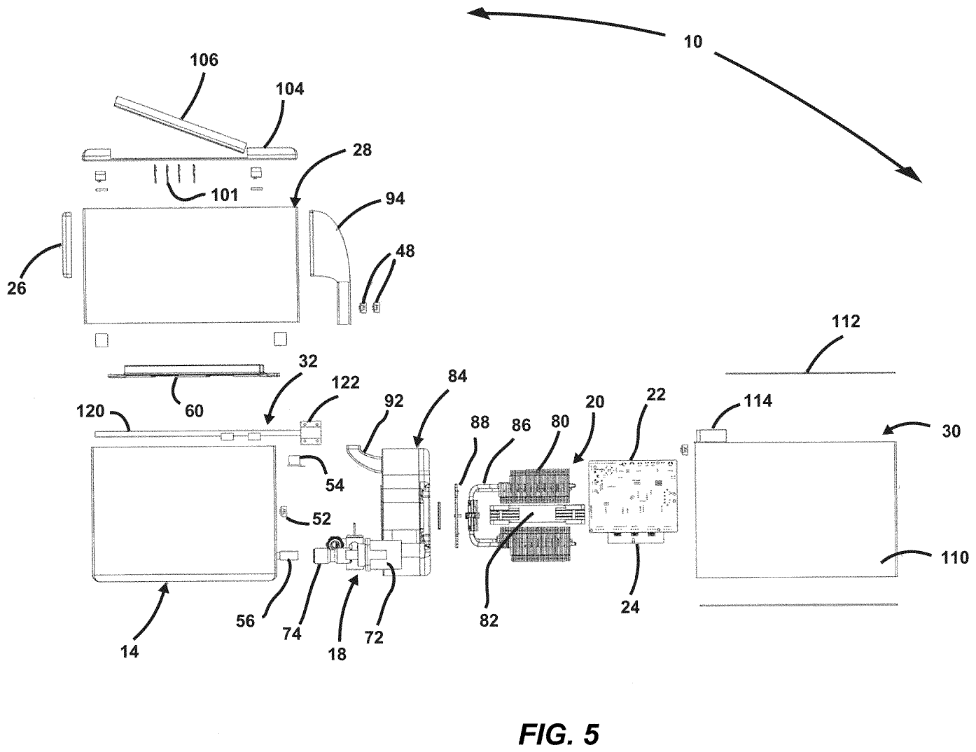

The cooking tank 14 described with reference to FIGS. 4 and 5. The cooking tank 14 includes an internal volume 50, a temperature sensor 52, a liquid height sensor 54, an inlet 56, and an outlet 58. The internal volume 50 may hold a volume of liquid such as water, although other types of liquids may be used in place of or in addition to water. The height sensor 54 measures a height of the liquid in the internal volume 50. In at least some embodiments, the cooking device 10 may be connected in flow communication with a source of water or other liquid and be operable to increase or decrease the height of the liquid stored in the internal volume 50 depending on, for example, the size, shape or volume of the food item being cooked in the cooking tank 14, a need to reduce the temperature of the liquid stored in the internal volume 50, or initially fill the cooking tank 14 with a liquid. Similarly, the cooking tank 14 may be coupled in flow communication with a drain such that the cooking device is operable to remove some or all of the liquid from the cooking tank 14 as desired.

The temperature sensor 52 may monitor the temperature of the stored liquid. The cooking device 10 may operate to increase or decrease the temperature of the liquid based on the sensed temperature using, for example, the heater assembly 18 described in further detail below.

The inlet 56 and outlet 58 provide flow of the liquid into and out of the internal volume 50 as needed to control the temperature of the liquid stored in the internal volume 50.

The door assembly 16 is described with reference to FIGS. 3A and 4. The door assembly 16 includes doors 60 and associated actuators 62. A separate door 60 may be associated with each of the bays 40. The actuators 62 may operate to open the doors 60. In one example, the actuators 62 include electromechanically-actuated devices. Many other types of actuators are possible including, for example, motors (e.g. electro-mechanically actuated motors), cables, biasing members that apply a biasing force, and the like. While a separate door is shown for each of the bays 40, other embodiments may include one door that controls access to multiple bays, or multiple doors that provide access to a single bay. Typically the doors 60 are insulated so as to maintain a temperature differential between the cooking tank 14 and the interior of the bays 40. The doors 60 may rotate about hinges 64 (see FIG. 4) or similar structure that provides rotating, pivoting, sliding, or the like motion to provide movement of the doors 60 between open and closed positions.

The heater assembly 18 is shown with reference to FIGS. 3A-5. The heater assembly 18 includes a heater 70 positioned in a liquid flow line 74, and a pump 72. The liquid flow lines 74 are connected to the inlet and outlet 56, 58 of the cooking tank 14. The pump 72 draws liquid from the cooking tank 14 through the outlet 58, and into the heater 70 where the liquid is heated and back into the cooking tank 14 via the inlet 56. The heater assembly 18 may be connected to a separate source of liquid such as a cool liquid that bypasses the heater 70. The source of cool liquid may be used to reduce the temperature of the liquid in the cooking tank 14 rather than waiting for heat dissipation alone to lower the temperature of the liquid. In some embodiments, the pump 72 is connected to a drain and the pump 72 operates to remove the liquid from the cooking tank 14 in order to empty the cooking tank 14.

The refrigerator assembly 20 is shown with reference to FIGS. 3A-5 to include a plurality of heat sinks 80, a fan 82, a refrigeration unit 84, and a temperature sensor 96. A refrigeration unit 84 includes heat pipes 86, a cooling component 88 (e.g., a Peltier Tile (TEC—cooling component)), and a fan 90, and air ducts 92, 94. The refrigeration unit 84 circulates liquid through the heat pipes 86 into the heat sinks 80 where the fan 82 operates to dissipate heat generated by the heat pump 88 using the heat sinks 80 as part of reducing the temperature of a liquid flowing through the heat pipes 86. As the heat sinks 80 heat up, the heat pipes 86 circulate hot water away from the metal pad touching the cooling component 88 and back into the fins of heat sinks 80 and fan 82 to cool off. The fan 90 may be used to dissipate heat in the refrigeration unit 84. The refrigeration unit 84 may generate a flow of cooled air that is transferred through air ducts 92, 94 into the bays 40. The fan 90 helps circulate cold air through the cooling unit and the refrigerated food storage compartment 12. Behind the fan 90 is a heat sink (i.e., cold sink) that the cooling component 88 is in contact with. This heat sink (i.e., cold sink) in turn gets cold and the fan 90 blows less cold air form the refrigerator over the heat sink (i.e., cold sink) to cool down even more before circulating back into the bays of the food storage compartment 12.

In some embodiments, the heat sinks 80 comprise a Peltier style heat sink. Many types of refrigeration units with various features and functionality may be used to provide a source of cooled air or other fluid to the food storage compartment in order to maintain a desired temperature within the bays 40. In some embodiments, the refrigerator assembly is integrated into the upper housing assembly 28 within which the food storage compartment 12 is located. In still other embodiments, the refrigerator assembly 20 is part of another appliance such as, for example, a refrigerator appliance within which the food storage compartment 12 is located. The features of the refrigerator assembly 20 shown in FIGS. 1-5 provide a relatively compact, efficient way to generate and maintain a reduced temperature environment within the bays 40. The reduced temperature environment may be in the range of, for example, about 0° F. to about 50° F. (e.g., in the range of frozen to refrigerated conditions), and more particularly in the range of about 33° F. to about 40° F. (e.g., refrigerated conditions only).

The controller 22 may be a programmable device. The programming may occur prior to use of the cooking device 10. Alternatively, some functionality of controller 22 may be based on user input via, for example, the user interface 26. The controller 22 may control, for example, the heater assembly 18 to maintain a predetermined temperature for the liquid stored in cooking tank 14. The controller 22 may control operation of the refrigerator assembly 20 to maintain a predetermined temperature condition within the bays 40 of the food storage compartment 12. The controller 22 may control the door assembly such as, for example, operating the actuators 62 and related features to open and/or close the doors 60. In other embodiments, the controller 22 may operate to move the food storage compartment 12 relative to the cooking tank 14, communicate, via a network, with a user or other appliance (e.g., another sous-vide cooking device 10) as will be described in further detail below.

The power supply 24 may provide power to the various electronic components of the cooking device 10. The cooking device 10 may include a power switch located on an exterior of the cooking device 10 for manual operation by a user. Alternatively, the power supply 24 may be controlled electronically via, for example, the controller 22 to turn on or off various features and functionality of the cooking device 10.

The user interface 26 is shown in FIGS. 4 and 5 positioned along an exposed surface of the upper housing assembly 28. The user interface 26 may be positioned at other locations on the cooking device 10 such as, for example, along a side surface of the upper housing assembly 28, or along any surface of the lower housing assembly 30 or the cooking tank 14. The user interface 26 may include, for example, a touch screen configured to receive touch inputs from a user. The user interface 26 may include buttons, switches, speakers, microphones, displays, images, and the like to provide communications with and/or receive inputs from a user. A user interface 26 may provide an interactive experience with the user that includes, for example, audio, visual, tactile, and other forms of communication.

The food storage compartment 12 may be positioned within the upper housing assembly 28. A space or gap provided between the food storage compartment 12 and the upper housing assembly 28 may be filled or at least partially filled with an insulating material such as foam, or the like. The insulating material may assist with maintaining a desired temperature within bays 40 and minimize heat transfer. The upper housing assembly 28 may include an upper housing 100 that includes a top opening 102. A cover 104 may be positioned to at least partially cover the top opening 102. A lid 106 may be moveable between opened and closed positions to provide access to the bays 40. The cover 104, lid 106, and other features of the food storage compartment 12 and upper housing assembly 28 may include insulated materials. As mentioned above, insulation 108 may be positioned surrounding at least some features of the food storage compartment 12, and may also encircle or enclose the air ducts 94. The air ducts 94 are positioned within the upper housing 100 and are in flow communication with the rear vents 42 on the bays 40. The insulation 108 is removed from at least some of the figures of the application in order to illustrate other features of the cooking device 10.

The lower housing assembly 30 includes a lower housing 110, a lid 112, and vent openings 114. The vent openings 114 provide a flow path between the air ducts 92, 94. The lid 112 may be removable to provide access to the heater assembly 18 and refrigerator assembly 20.

The rail assembly 32 includes rails 120 and rollers and/or bearings 122 as shown in FIGS. 4 and 5. The upper housing assembly 28 with food storage compartment 12 may move along the rails 120 using the rollers 122 between the first and second positions shown in FIGS. 2A and 2B. The rail assembly 32 may be replaced with other types of connecting features that provide relative movement between the upper housing assembly 28 and the cooking tank 14 and lower housing assembly 30. In other embodiments, the rail assembly 32 may include hinges, linkages, brackets, fasteners, and the like. In at least some embodiments, the rail assembly 32 or similar device may be powered (e.g., using a motor) and controlled automatically via, for example, controller 22.

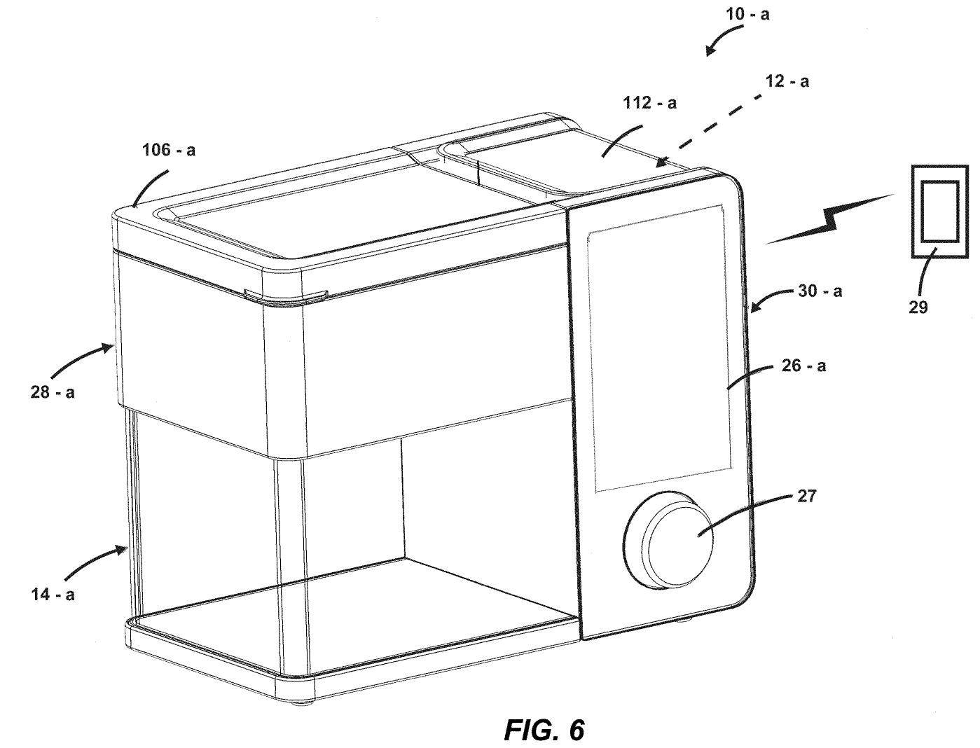

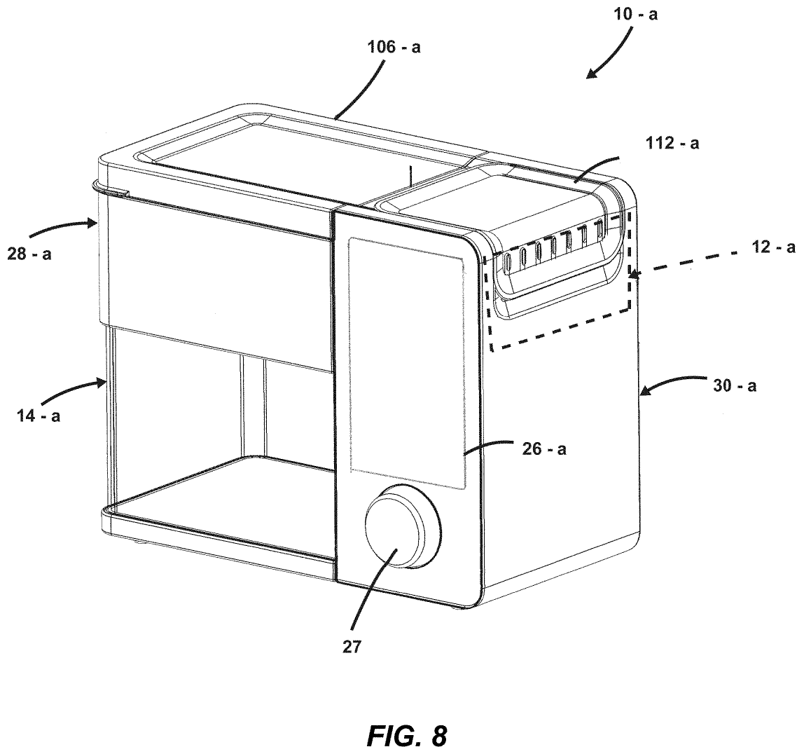

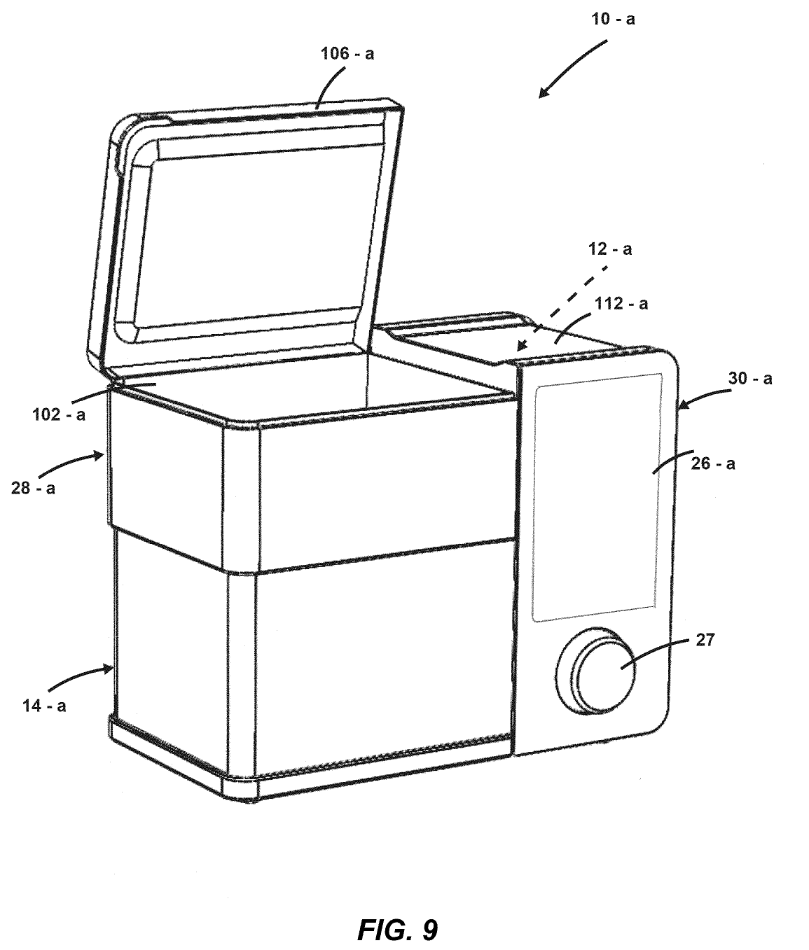

Referring now to FIGS. 6-9, another example sous-vide cooking device 10-a is shown and described. The cooking device 10-a includes a food storage compartment 12-a, a cooking tank 14-a, a user interface 26-a, housing assemblies 28-a, 30-a, and a selection member 27. The food storage compartment 12-a in enclosed in the housing assembly 30-a. A lid 112-a may provide access to the food storage compartment 12-a. The cooking tank 14-a may be accessed using a lid 106-a, which is shown in a closed position in FIGS. 6-8 and rotated into an open position as shown in FIG. 9. The cooking device 10-a may be controlled by entering commands via the user interface 26-a, the selection member 27, or a remote device 29, such as a mobile handheld computing device, shown in FIG. 6. The remote device 29 may be connected to the cooking device 10-a through a wired or wireless connection.

The cooking device 10-a may include other features and functionality similar to what is included in the cooking device 10 described above with reference to FIGS. 1-5. The components and features of cooking device 10-a may be arranged differently and/or have different sizes and/or shapes as compared to the components and features of cooking device 10, but may still provide substantially similar functions. For example, the food storage compartment 12-a may include a door assembly, and at least one bay, although a plurality of bays may be used for a single food storage compartment 12-a. The walls defining the food storage compartment 12-a may include passages that are in flow communication with a source of refrigerated air, and may be part of a closed refrigeration system used to maintain the various bays at a predefined temperature. The bays may include a top opening accessible when the lid 112-a is open, a bottom opening controlled by the door assembly, and at least one temperature sensor. The food storage compartment 12-a generally is positioned vertically above the cooking tank 14-a, but may be positioned laterally relative to the cooking tank 14-a. The door assembly may provide for delivery of the food item stored in the various bays in a downward and partially lateral direction.

The cooking tank 14-a may include an internal volume, at least one temperature sensor, a liquid height sensor, an inlet, and an outlet, similar to the features described above related to cooking device 10. The internal volume may hold a volume of liquid such as water, although other types of liquids may be used in place of or in addition to water. The height sensor measures a height of the liquid in the internal volume. In at least some embodiments, the cooking device 10-a may be connected in flow communication with a source of water or other liquid and be operable to increase or decrease the height of the liquid stored in the internal volume depending on, for example, the size, shape or volume of the food item being cooked in the cooking tank 14-a, a need to reduce the temperature of the liquid stored in the internal volume, or initially fill the cooking tank 14-a with a liquid. Similarly, the cooking tank 14-a may be coupled in flow communication with a drain such that the cooking device is operable to remove some or all of the liquid from the cooking tank 14-a as desired. The cooking tank 14-a may comprise a transparent or translucent material that permits viewing of the internal volume through the sidewall of the cooking tank 14-a.

The temperature sensor may monitor the temperature of the stored liquid. The cooking device 10-a may operate to increase or decrease the temperature of the liquid based on the sensed temperature using, for example, a heater assembly of the cooking device 10-a (e.g., positioned in housing assembly 30-a.

The door assembly of the cooking device 10-a includes one or more doors and associated actuators. A separate door may be associated with each of the bays. The actuators may operate to open the doors. In one example, the actuators include electromechanically-actuated devices. Many other types of actuators are possible including, for example, motors (e.g. electro-mechanically actuated motors), cables, biasing members that apply a biasing force, and the like. While a separate door is shown for each of the bays, other embodiments may include one door that controls access to multiple bays, or multiple doors that provide access to a single bay. Typically the doors are insulated so as to maintain a temperature differential between the cooking tank 14-a and the interior of the bays. The doors may rotate about hinges or similar structure that provides rotating, pivoting, sliding, or the like motion to provide movement of the doors between open and closed positions in order to facilitate delivery of the food items stored in the bays into the cooking tank 14-a.

The heater assembly of the cooking device 10-a may include a heater positioned in a liquid flow line that circulates liquid through the cooking tank 14-a, and a pump to provide circulation of the liquid. The liquid flow lines are connected to the inlet and outlet of the cooking tank 14-a. The pump draws liquid from the cooking tank 14-a through the outlet and into the heater where the liquid is heated and then delivered back into the cooking tank 14-a via the inlet. The heater assembly may be connected to a separate source of liquid such as a cool liquid that bypasses the heater. The source of cool liquid may be used to reduce the temperature of the liquid in the cooking tank 14-a rather than waiting for heat dissipation alone to lower the temperature of the liquid. In some embodiments, the pump is connected to a drain and the pump operates to remove the liquid from the cooking tank 14-a in order to empty the cooking tank 14-a.

The cooking device 10-a may include a refrigerator assembly positioned in the housing assembly 30-a. The refrigerator assembly may include at least one heat sinks, a fan, a refrigeration unit, and a temperature sensor, similar to those features of the cooking device 10. The refrigeration unit includes heat pipes, a cooling component (e.g., a Peltier Tile (TEC—cooling component)), and a fan, and air ducts. The refrigeration unit circulates liquid through the heat pipes into the heat sinks where the fan operates to dissipate heat generated by the heat pump using the heat sinks as part of reducing the temperature of a liquid flowing through the heat pipes. As the heat sinks heat up, the heat pipes circulate hot water away from the metal pad touching the cooling component and back into the fins of heat sinks and fan to cool off. The fan may be used to dissipate heat in the refrigeration unit 4. The refrigeration unit may generate a flow of cooled air that is transferred through air ducts into the bays. The fan helps circulate cold air through the cooling unit and the refrigerated food storage compartment 12-a. A heat sink (i.e., cold sink) may be positioned adjacent to the fan and the cooling component may be in contact with heat sink. This heat sink (i.e., cold sink) in turn gets cold and the fan blows less cold air form the refrigerator over the heat sink (i.e., cold sink) to cool down even more before circulating back into the bays of the food storage compartment 12-a.

In some embodiments, the heat sinks comprise a Peltier style heat sink. Many types of refrigeration units with various features and functionality may be used to provide a source of cooled air or other fluid to the food storage compartment in order to maintain a desired temperature within the bays. In some embodiments, the refrigerator assembly is integrated into a portion of the housing assembly 30-a within which the food storage compartment 12-a is located. In still other embodiments, the refrigerator assembly is part of another appliance such as, for example, a refrigerator appliance within which the food storage compartment 12-a is located. The features of the refrigerator assembly may provide a relatively compact, efficient way to generate and maintain a reduced temperature environment within the bays. The reduced temperature environment may be in the range of, for example, about 0° F. to about 50° F. (e.g., in the range of frozen to refrigerated conditions), and more particularly in the range of about 33° F. to about 40° F. (e.g., refrigerated conditions only).

The cooking device 10-a may include a controller, which may be a programmable device. The programming may occur prior to use of the cooking device 10-a Alternatively, some functionality of controller may be based on user input via, for example, the user interface 26-a. The controller may control, for example, the heater assembly to maintain a predetermined temperature for the liquid stored in cooking tank 14-a. The controller may control operation of the refrigerator assembly to maintain a predetermined temperature condition within the bays of the food storage compartment 12-a. The controller may control the door assembly such as, for example, operating the actuators and related features to open and/or close the doors. In other embodiments, the controller may operate to move the food storage compartment 12-a relative to the cooking tank 14-a, communicate, via a network, with a user or other appliance (e.g., another sous-vide cooking device 10-a).

The power supply of the cooking device 10-a may provide power to the various electronic components of the cooking device 10-a. The cooking device 10-a may include a power switch located on an exterior of the cooking device 10-a for manual operation by a user. Alternatively, the power supply may be controlled electronically via, for example, the controller to turn on or off various features and functionality of the cooking device 10-a.

The user interface 26-a is shown positioned along an exposed surface of the housing assembly 30-a. The user interface 26-a may be positioned at other locations on the cooking device 10-a such as, for example, along a surface of the housing assembly 28-a, or along other surfaces of the housing assembly 30-a or the cooking tank 14-a. The user interface 26-a may include, for example, a touch screen configured to receive touch inputs from a user. The user interface 26-a may include buttons, switches, speakers, microphones, displays, images, and the like to provide communications with and/or receive inputs from a user. A user interface 26-a may provide an interactive experience with the user that includes, for example, audio, visual, tactile, and other forms of communication.

The selection member 27 may be operable to select various options visible on the user interface 26-a. The selection member 27 may include push button and/or rotation capability to facilitate user actuation and/or selection. The selection member 27 may be positioned at any desired location on the cooking device 10-a, although a location adjacent to the user interface 26-a may be preferred in some embodiments.

The food storage compartment 12-a may be positioned within the housing assembly 30-a. In other embodiments, some or all of the food storage compartment 12-a may be positioned in the housing assembly 28-a. A space or gap provided between the food storage compartment 12-a and the upper housing assembly 28-a may be filled or at least partially filled with an insulating material such as foam, or the like. The insulating material may assist with maintaining a desired temperature within bays and minimize heat transfer. The housing assembly 28-a may include a lid 106-a. The housing assembly 30-a may include a lid 112-a that provides access to the bays of the food storage compartment 12-a. The lids 106-a, 112-a may be connected with a hinge connection and rotation between open and closed positions. The lids 106-a, 112-a may have other types of connections and operate through different types of motions in other embodiments.

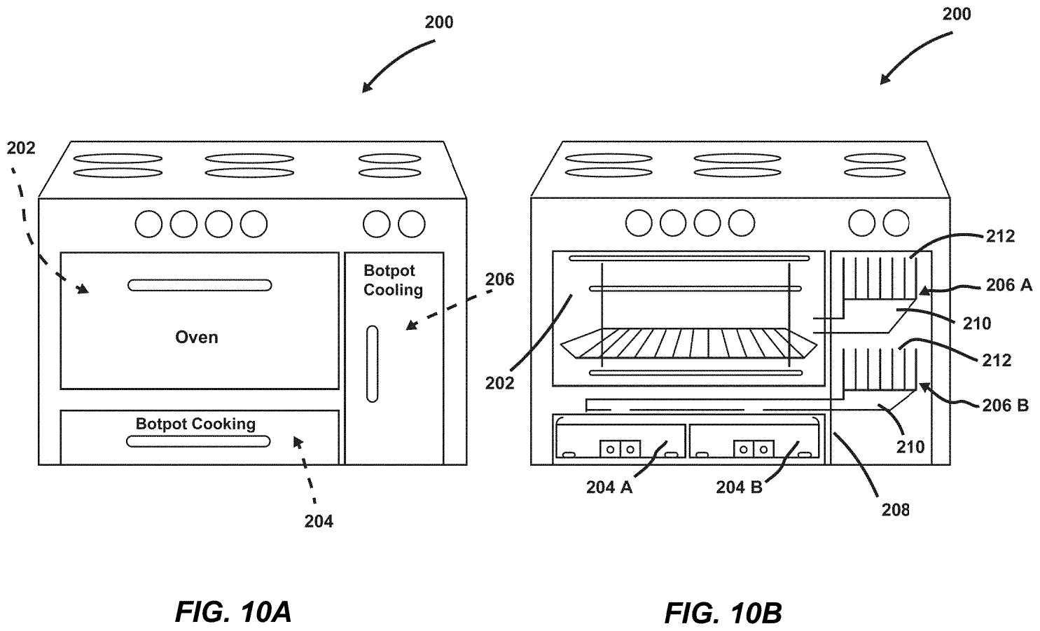

Referring to FIGS. 10A and 10B illustrate an oven appliance 200 have sous-vide cooking device integrated therein. The oven 200 includes an oven cooking compartment 202, a cooking tank 204, a food storage compartment 206, and food transport system 208, and a door assembly 210. The food storage compartment 206 may be positioned laterally to the side of the oven cooking compartment 202. The food storage compartment 206 may include one or more food bays 212. The door assembly 210 may operate to dispense a food item stored in the bays 212 directly into the oven cooking compartment 202. Alternatively, the door assembly 210 may operate to dispense a food item directly into the cooking tank 204. The cooking tank 204 may be positioned vertically below the oven cooking compartment 202. Alternatively, the cooking tank 204 may be positioned vertically below the food storage compartment 206. In some embodiments, a distance between the food storage compartment 206 and the cooking tank 204 requires use of a food transport system 208 that moves the food item from the food storage compartment 206 laterally or otherwise into the cooking tank 204.

FIG. 10B illustrates separate food storage compartments 206a and 206b that are dedicated to dispensing food items into the oven cooking compartment 202 and cooking tank 204, respectively. Many other configurations are possible for the oven appliance 200 including, for example, using a single food storage compartment 206, using three or more food storage compartments 206, using two or more cooking tanks 204a, 204b as shown in FIG. 10B, or the like. The other features and functionality described above with reference to cooking device 10 may be integrated in whole or in part to the oven appliance 200. For example, the food storage compartment 206 and/or cooking tank 204 may be moveable relative to each other. Alternatively, doors, lids, drawers, or the like may be operable to provide access to and/or move the cooking tank 204 and food storage compartment 206.

In one embodiment, a lid to food storage compartment 206, which may be refrigerated as described above, may be opened to reveal all of the bays 212 and allow the user to load each bay according to their wishes. The bays may be separated from the oven cooking compartment 202 with electromechanically actuated, thermally insulated bay doors that are part of door assembly 210. The doors of the door assembly 210 may operate in a trap-door fashion so that upon receipt of a signal from a controller (e.g., controller 22 described above), the door associated with a given bay 212 is opened, thus dispensing the food item into the oven cooking compartment 202. The door may close automatically. The food item may transfer by gravity forces from the food storage compartment 206 into the oven cooking compartment 202. In some embodiments, an insulated, heat-reflective bay door may be used as an interface between the oven cooking compartment 202 and the food storage compartment 206.

The food transport system 208 may include, for example, rollers, belts, robotic arms, or the like. The food items may be stored in food packages that are identified using, for example, a passive RFID module or automatic QR code reader positioned inside the food storage compartment 206, cooking tank 204 and/or oven cooking compartment 202. FIG. 5 shows a plurality of readers 101 (e.g., RFID and/or QR code readers) positioned for operation in the food storage compartment.

The figures primarily focus on cooking device embodiment that includes a single cooking tank and a single heater and related pumps that circulate fluid through that single cooking tank. Other embodiments may include multiple cooking tanks in a single cooking device, or a single cooking tank with multiple divided spaces for cooking food items. In some embodiments, a separate heater and related pump may be used for each cooking tank or divided space within a given cooking tank. Alternatively, multiple heaters and/or pumps may be used to support a single cooking tank or multiple cooking tanks. One embodiment is directed to a sous-vide cooking device having a dual cooking tank or a multi-chamber cooking tank.

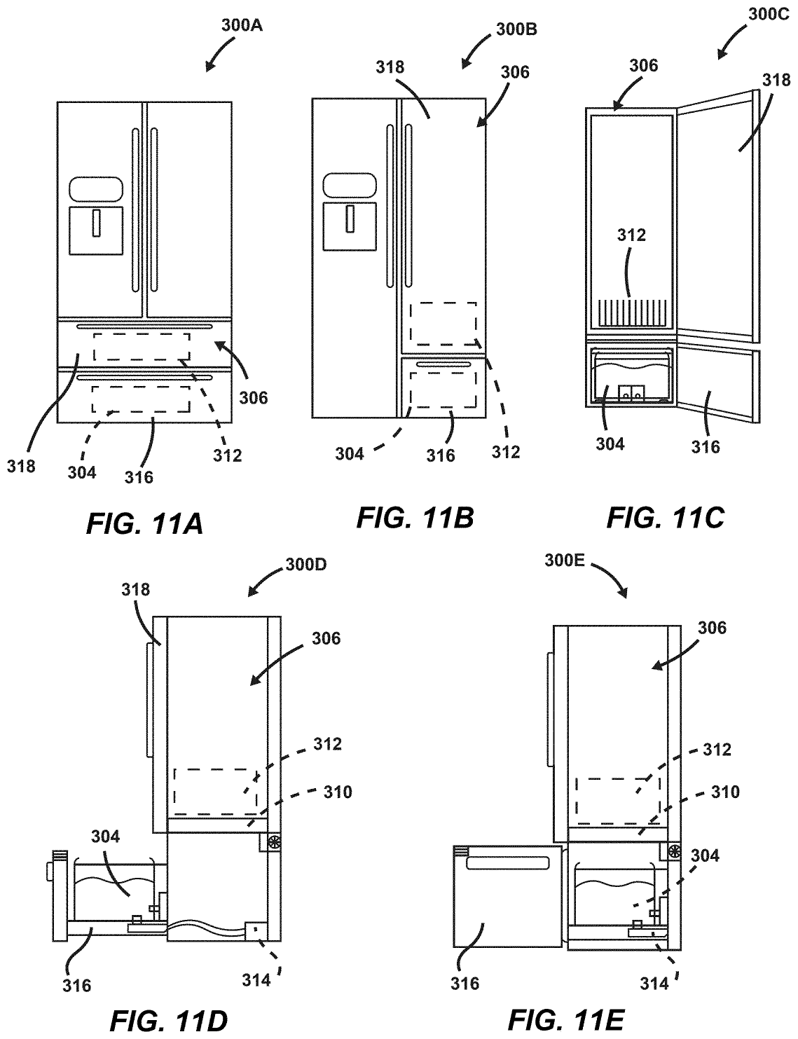

FIGS. 11A-11E illustrate a refrigerator appliance 300 that includes a sous-vide cooking device integrated therein. The refrigerator appliance 300 includes a cooking tank 304, a food storage compartment 306, a door assembly 310, a heating system 314, and a drawer or door 316. The embodiment of FIG. 11A illustrates a refrigerator appliance 300 that includes a lower drawer 316 having the cooking tank 304 positioned therein, and a top drawer 318 having the food storage compartment 306 positioned therein. The food storage compartment 306 may maintain a relatively low temperature environment for a plurality of bays 312 using the refrigerator system of the refrigerator appliance 300 rather than using a separate refrigerator system solely for the food storage compartment 306. The drawers 316, 318 may be moved in and out as needed to provide access to the cooking tank 304 and food storage compartment 306.

FIG. 11B shows an embodiment for refrigerator appliance 306B that includes the cooking tank 304 positioned in drawer 316 and positioned vertically below a food storage compartment 306 that is integrated into an existing refrigerated (or freezer) section of the refrigerator appliance 300B. The drawer 316 may be operable to provide access to the cooking tank 304. A door 318 or drawer of the refrigerator appliance 300B may be operable to provide access to the bays 312. In some embodiments, the food storage compartment 306 is integrated into a crisper drawer or space of the refrigerator appliance 300B.

FIG. 11C shows an embodiment of a refrigerator appliance 300C that includes a food storage compartment 306 positioned within an existing refrigerated compartment of the refrigerator appliance, and a cooking tank 304 positioned below the food storage compartment 306. A door 316 may be operable to provide access to the cooking tank 304. The food storage compartment 306 may be substantially larger than what is needed for the bays 312. The remaining open space of the food storage compartment 306 may be used to store other food items that are not intended to be cooked in the cooking tank 304, or at least are not currently positioned within one of the bays 312 for dispensing into the cooking tank 304.

FIG. 11D shows a refrigerator appliance 300D that may be an example of the refrigerator appliance 300B described above. FIG. 11D shows the food storage compartment 306 pulled outward on a drawer to provide access to the cooking tank 304. The heating system 314 may be mounted stationary to the food storage compartment 306.

FIG. 11E shows another refrigerator appliance 300e that includes a swinging door 316 or drawer to provide access to the cooking tank 304. The cooking tank 304 may remain fixed relative to the food storage compartment 306. Alternatively, the cooking tank 304 may slide on a separate tray or set of rollers, or may be lifted out of its stored position shown in FIG. 11E. The heating system 314 may remain stationary relative to the cooking tank 304.

The bays 312 may be positioned within the refrigerator appliance 300 for holding multiple food selections. The main refrigerator door 318 may be opened to reveal all of the bays 312 and allow the user to load each bay according to their wishes. These bays may be located near the bottom level of a refrigerated space and/or freezer space, such as alongside an inner door, positioned in or on an inner door, or the like.

When bays 312 are located on a lower refrigerator level, the bays 312 may be separated from the bottom cooking tank 304 using, for example, electromechanically-actuated, thermally-insulated bay doors that operate in a trap-door fashion. The doors may, upon receipt of a signal from a controller, open the bay 312 for dispensing of the food item under gravity forces into the cooking tank 304. The doors may close automatically. For bays located within a refrigerator side panels or doors, a vending machine style system may move (e.g., drop) food articles down into the cooking tank 304. Individual bays 312 may be activated to open using controlled doors as discussed above. The doors may be controlled remotely (e.g., via a wireless signal). Many other types of actuation and control for the bay doors may be possible.

As discussed above, the cooking tank 304 may be part of the refrigerator appliance 300. The cooking tank 304 may be thermally insulated and positioned on a bottom side of the refrigerator. The cooking tank 304 may be connected in flow communication with a water supply such as a water supply used for an ice maker of the refrigerator appliance 300. The cooking tank 304 may include one or a plurality of cooking tanks or compartments. Each of the cooking tanks may include a liquid inlet and a liquid outlet The liquid outlet may be routed through a series of valves and pumps to automatically fill the cooking tank for use during cooking operations. An exit valve and pump may allow the cooking tank liquid to be automatically pumped out and drained after the cooking process is completed or during automatic self-cleaning. Alternatively, individual cooking tanks may be disconnected from inlet and outlet valves, thus allowing the user to refill and empty the cooking tanks manually as desired.

In some embodiments, fans may be included in the refrigerator appliance 300 such as, for example, near a top of the cooking tank 304 to pull air from a rear side of the refrigerator appliance 300 and push the air over the top of the cooking tank 304 and through external vents on a front side of the refrigerator appliance 300. This movement of air may reduce excess water and steam buildup within the cooking tank 304 and refrigerator appliance 300 generally that may otherwise adversely affect the refrigerator appliance 300.

Once the food item is positioned within the cooking tank, the food item cooks at a desired temperature and for an amount of time as predetermined by the user. The temperature of the liquid in the cooking tank 304 may be monitored by one or more sensors. The temperature of the liquid may be controlled using, for example, a closed-loop heater and pump that draw liquid from the cooking tank 304, heat the liquid, and return the liquid to the cooking tank 304. A rear of the cooking tank 304 may contain heater and pump components, electronic control hardware, and the like. Generally, the refrigerator appliance 300 and the sous-vide cooking device features described herein may be networked via, for example, Wi-Fi or other wireless communications and controlled, for example, via a mobile computing device such as user's smart phone that operates an app or provides web-accessible interfaces.

The electronics for the sous-vide cooking device features of the refrigerator appliance 300 may be integrated into existing “smart” refrigerator system capabilities. A touch screen-enabled refrigerator appliance 300 may show all food items placed within the refrigerator 300, and allow the user to program and schedule cooking via both touch screen and wireless controls. As with other embodiments disclosed herein, the packaging for the food items may be identified by automatically using, for example, passive RFID modules or automatic QR code readers positioned in, for example, the cooking tank 304, the food storage compartment 306, etc.

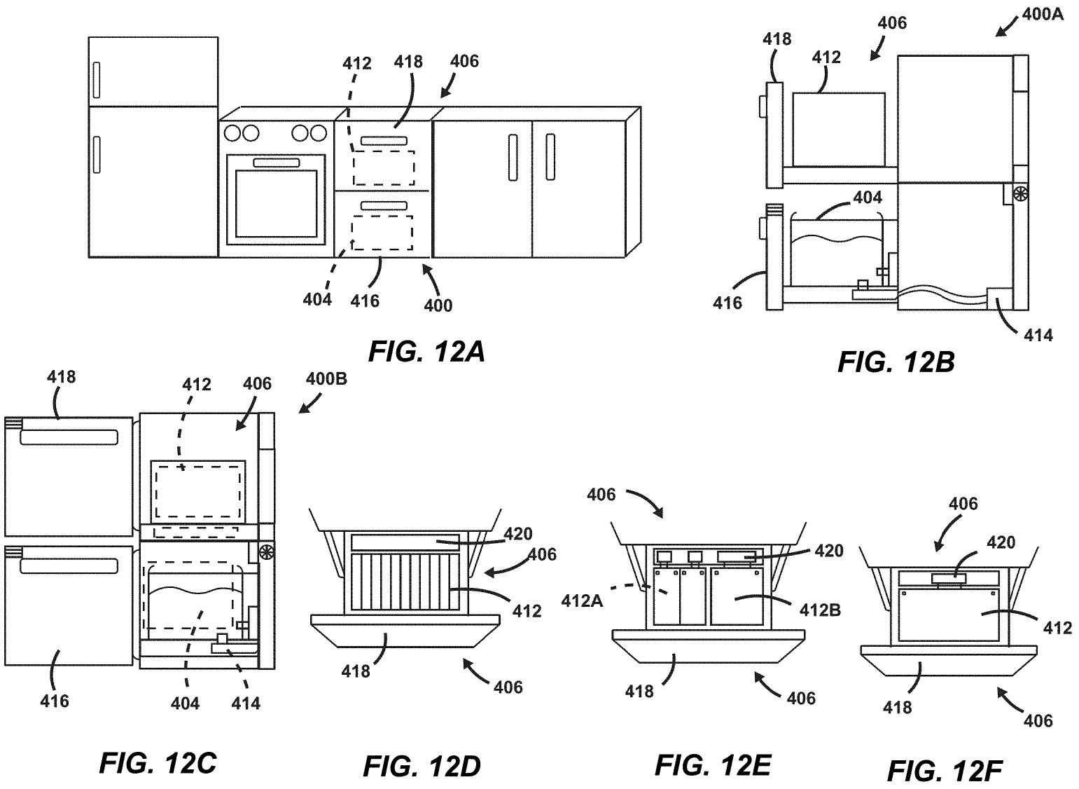

FIGS. 12A-12F illustrate a cabinet system 400 with a sous-vide cooking device integrated therein. The cabinet system 400 includes a cooking tank 404 positioned in a bottom cabinet 416 and a food storage compartment 406 positioned in a top cabinet 418. The food storage compartment 406 includes a plurality of bays 412 for storage of food articles. The cabinet 400 may be part of a cabinet system of a residential or commercial system. The cabinet 400 may be from appliances such as a refrigerator, oven, microwave, stovetop, etc., that is used in the kitchen as shown in FIG. 12A. FIG. 12B shows cabinet 400A wherein the bottom and top cabinets 416, 418 having drawer features that carry the cooking tank 404 and food storage compartment 406, respectively. The cabinet 400A may include a heating system 414 as shown in FIG. 12B. The heating system 414 may be affixed in the cabinet 400 relative to the moveable cooking tank 404. In other embodiments, the heating system 414 may be moveable with the cooking tank 404. The drawer arrangement shown in FIG. 12B may provide relatively easy access to each of the bays 412 of the food storage compartment 406 as well as access to the interior of cooking tank 404.

FIG. 12C shows another cabinet embodiment 400B wherein the bottom and top cabinets 416, 418 include doors that open and close to provide access to the interiorly enclosed cooking tank 404 and food storage compartment 406. In other embodiments, the food storage compartment 406 may be accessible from above by opening a lid or other access point along a counter surface above the cabinet 400.

FIGS. 12D-12F show different embodiments for the bays 412 of the food storage compartment 406. FIG. 12D illustrates a plurality of bays 412 each having the same size and shape. The bays 412 have a refrigerated temperature by operation of a refrigeration system 420. Each of the bays 412 may hold a separate food item. In some embodiments, multiple food items may be positioned within a single bay 412.

FIG. 12E shows a food storage compartment 406 with bays 412A and 412B in different sizes. The bays 412A and 412B may be sized to hold different sized food items or different amounts of food items. One or more refrigeration systems 420 may be used to provide a refrigerated conditions within the bays 412A, 412B.

FIG. 12F shows the food storage compartment 406 having a single bay 412. The various bay configurations shown in FIGS. 12A-12F may have one more doors associated with each bay. The doors may operate according to the descriptions provided above the door assembly 16.

Generally, the cabinet 400 may include a fully-refrigerated upper compartment set into a cabinet drawer and capable of holding multiple food selections in separate bays 412. The refrigerated storage compartment 406 may be pulled out (e.g., opened) to provide access to all of the bays 412 and allow the user to load each bay 412 according to their wishes. The food storage compartment 406 may be insulated and sealed against the cabinet drawer and frame of the cabinet to limit temperature loss.

The bays 412 may be separated from the cooking tank 404, which may be positioned directly vertically below the food storage compartment 406. The cooking tank may comprise a polycarbonate material. The bays 412 may be separated from the cooking tank 404 with the door assembly 410, which may comprise electromechanically-actuated, thermally-insulated doors that operate in a trap-door fashion. The doors, upon receipt of a signal from a controller, may open to dispense food items from the bays 412 into the cooking tank 404. A rear of the drawers associated with the bottom and top cabinets 416, 418 may contain refrigeration systems, cooling units, power supplies, electronic control hardware, and other components of the sous-vide cooking device.

The cooking tank 404 may be coupled in flow communication with water inlet and outlet for a main water supply of a home or building. The water inlet may be routed through a valve and pumped to automatically fill the cooking tank 404 during cooking operations. An exit valve and pump permits the cooking tank 404 fluid to be automatically pumped out and drained after the cooking process or during automatic self-cleaning. Alternatively, individual cooking port chambers of the cooking tank 404 may be removable or disconnected from a water inlet and outlet valves to permit the user to refill and empty the individual compartments of the cooking tank 404.

The cabinet 400 may also include fans or other air-moving devices positioned near a top portion of the cooking tank 404 to assist in removing air from the refrigeration system associated with the food storage compartment 406, push the air over the top of the cooking tank 404, and deliver the air through external vents along a front side of the cabinet 400. This air movement may reduce the presence of excess water and steam buildup within the cooking tank 404 and other portions of the cabinet 400 that may otherwise adversely affect the refrigeration system 420.

Once the food items enter the cooking tank 404, the food cooks in the liquid bath for a predetermined amount of time at a given temperature. The temperature of the liquid is monitored by one or more sensors and the temperature of the liquid is adjusted using a closed-loop heater and pump system that withdraws and re-inputs liquid relative to the tank. The rear portion of the bottom cabinet 416 may include the heating system and related electronic control hardware. The heating system 414 and refrigeration system 420 and other functionality of the cabinet 400 and related sous-vide cooking device may be networked via, for example, Wi-Fi or other wireless communications and controlled via, for example, a mobile handheld device such as a user's smart phone that operates an app or web-accessible interface.

The food items cooked in cooking tank 404 may be packaged, and the packaging may include identification capability for automatic identification by the sous-vide cooking device features. For example, passive RFID modules or automatic QR code readers may be positioned in proximity to the cooking tank 404 and food storage compartment 406 to automatically identify the food items.

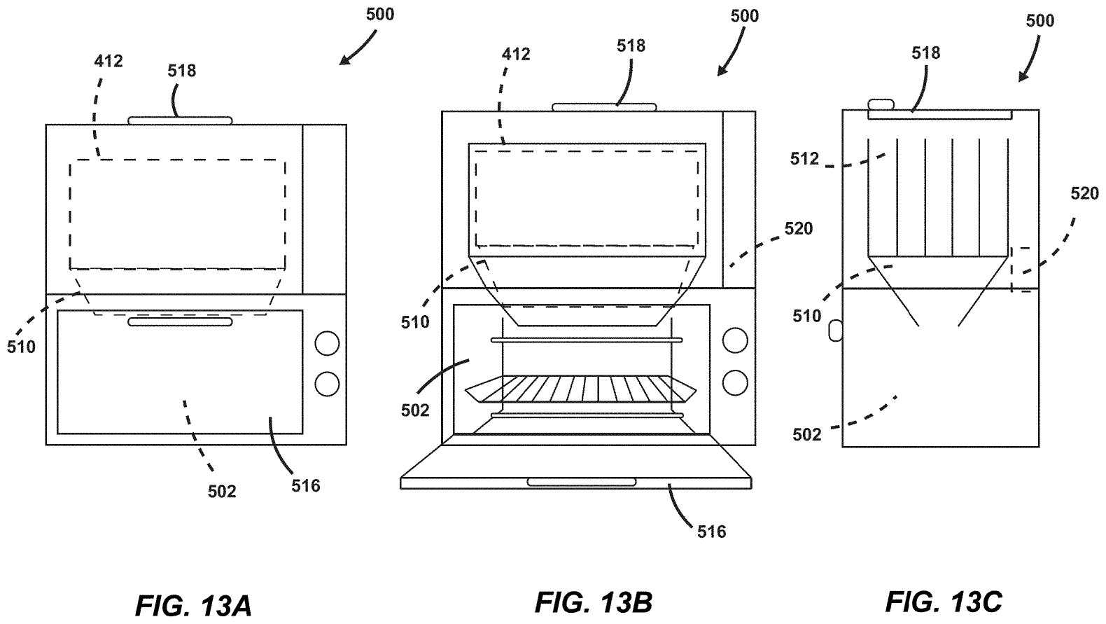

Referring now to FIGS. 13A-13C, a convection or a toaster oven 500 having sous-vide cooking device capabilities is shown and described. The oven 500 includes an oven cooking compartment 502, a food storage compartment 506, a door assembly 510, an oven door 516, and a lid 518. The food storage compartment 506 may include a plurality of bays 512 that are accessible via the lid 518. The lid 518 may be positioned along other surfaces such as, for example, a front surface of the oven 500 rather than the top surface as shown in the figures. The door assembly 510 may include a plurality of doors that are operable to dispense food items stored in the bays 512 directly into the oven cooking compartment 502. The door 516 may provide access to the oven cooking compartment 502.

The oven 500 may include controls that permit a user to remotely operate the oven 500 to both dispense the food item into the oven cooking compartment 502 and operate the oven cooking compartment 502 to cook the food item.

The food storage compartment may maintain a refrigerated condition in the bays 512 using a refrigeration system 520. The food storage compartment 506, related refrigeration system 520, and door assembly 510 may operate according to related features described above in other embodiments.

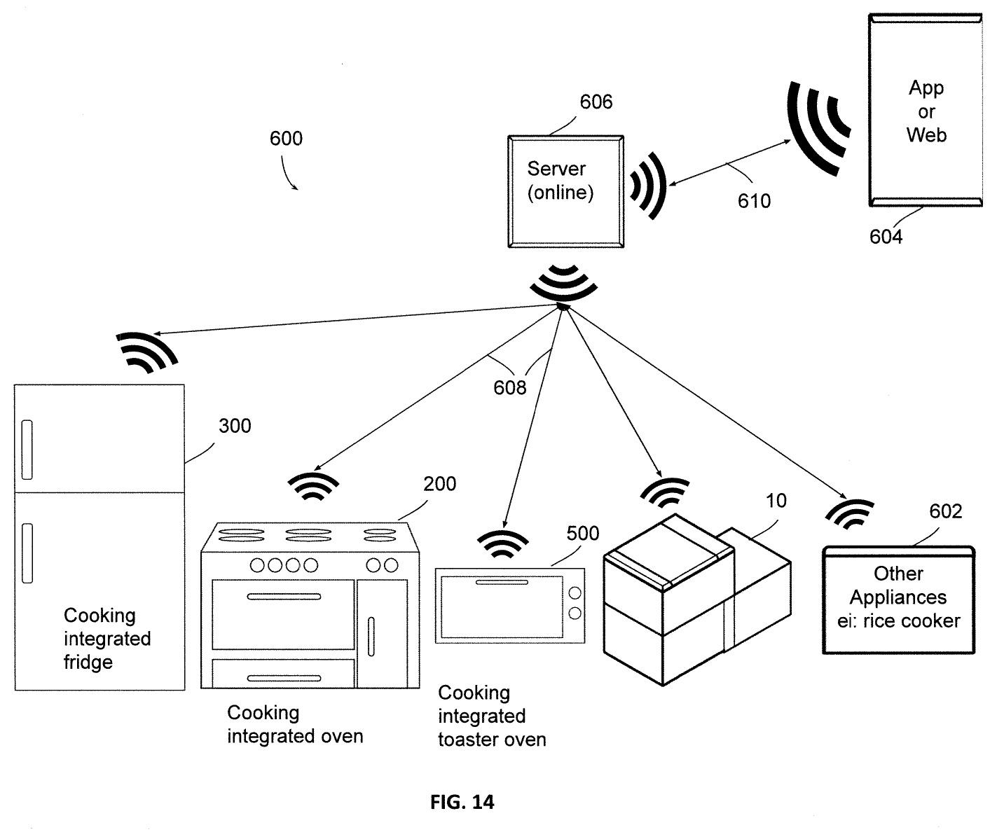

Referring now to FIGS. 14-17, several network appliance embodiments are shown and described. FIG. 14 shows a network 600 using a server 606 as a control hub for a kitchen. The server may be used to connect, via a network, a number of kitchen appliances including, for example, a refrigerator 300, an oven 200, a toaster oven 500, a sous-vide cooking device 10 and other appliances 602. Any of the appliances 10, 10-a, 200, 300, 500, 602 may include some or all of the features and functionality of the sous-vide cooking device 10 as described above with reference to FIGS. 1-14C.

A single wireless interface may be used to control and automate all connected wireless kitchen appliances. A “smart home” kitchen hub may provide increased controls, functionality, and options for cooking, some or all of which may include aspects of a sous-vide cooking device. All of the appliances shown in FIG. 14 may automatically connect, via server 606, or through a self-designated appliance prior to routing data to the server 606. Other appliances from other manufacturers operating an open software protocol may be able to connect to the server 606 using, for example, control, automation, scheduling, and user interface data. A variety of communication links 608, 610 may provide communications between the various components via the server 606.

Some features of the network 600 include single command and control interface for all smart kitchen appliances. The network 600 may provide scheduling and planning of meals and/or cooking by collaborating multiple appliances. The network 600 may allow additional appliances to join the network 600 and communicate between the existing appliances in the network 600. The network 600 may allow real-time appliance data monitoring such as temperatures, food contents, and the like. The network 600 may provide tracking of user activity via, for example, a mobile application. The tracking may involve, for example, using live location tracking, traffic delays, and unexpected errands to update system cooking times and scheduling. The tracking capability may limit the possibility of overcooking meals or having the meals cold on arrival home.

The network 600 may also be capable of notifying the details of a meal, (e.g., a dinner meal) to anticipated guests of the meal related to cooking progress, scheduling, and other up-to-date information. Conversely, the network 600 may take into account expected guest delays by providing options/suggestions to alter the cooking schedule for certain portions and/or packages of food until the delayed guests arrive. This allows a host of a meal to configure and customize guests notifications and link social media updates and notifications.

The network 600 also may offer custom menu planning given purchased food options and input from the user such as pre-purchased or grocery-market purchased food. This may include preparation suggestions and loading instructions for the particular food items.

The network 600 may also provide user pattern recognition and suggested actions based on those use cases. For example, the network 600 may provide preheating of certain cooking chambers prior to expected cooking commands, automatically place orders for new food packages and meals based on user cooking and preference patterns. For example, steak always eaten first and manual order leaves steak empty, so auto-order such that user is never without steak or green beans always ordered but rarely cooked enough and thrown out due to spoiling, so suggest order/meal alternatives and replace with contents more preferable to user.

The network 600 may also link a user calendar and schedule to optimize meal planning and cooking time. This may include integrating with multiple users to create optimal meal scheduling.

In an office or work environment, the network 600 may link with employees and visitors to provide available meal choices, ordering and cooking scenarios. The network 600 may link to a chef and kitchen staff for menu planning including such feedback as popular versus unpopular choices, busy or low cooking times, automatic ordering, and user poll information for future meals/menu planning. The network 600 may provide integrated ordering and purchasing platforms, which may include preheating and beginning of a cooking process prior to certain meal times, and provides the benefit of minimized time spent ordering and people waiting in line for their food.

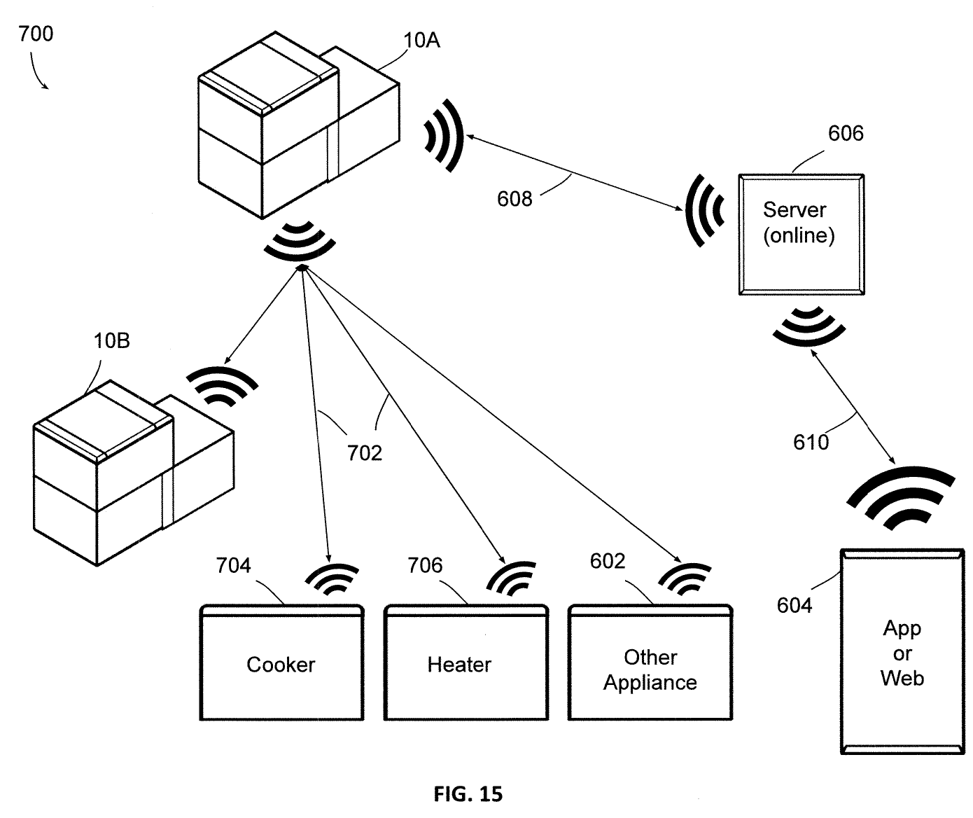

FIG. 15 illustrates another network 700 that includes a plurality of sous-vide cooking devices 10A, 10B, a cooker 704, a heater 706, and other appliances 602. The cooking device 10A may communicate with a server 606. An app or web interface 604 may be used to control the cooking device 10A via the server 606. A cooking device 10A may communicate with other appliances via communication links 702.

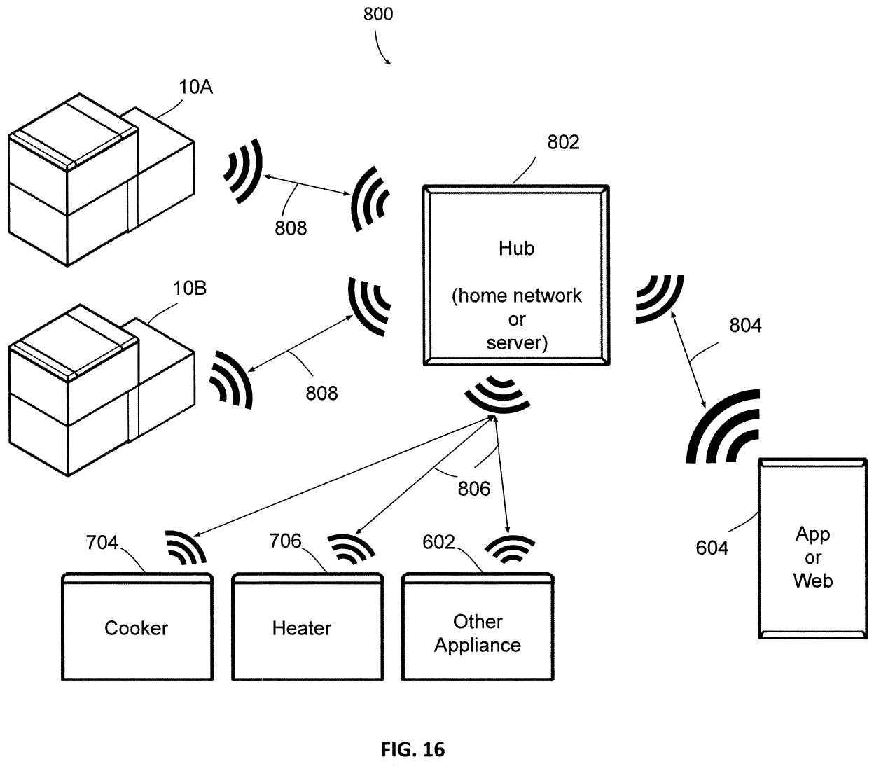

FIG. 16 shows another network 800 using a home network or a home server as a hub 802. The hub 802 communicates with the sous-vide cooking devices 10A, 10B via communication links 808, communicates with other devices 704, 706, 602 via communication links 806, and communicates with a mobile app or web interface 604 via a communication link 804. The networks 700, 800 provide multiple options for a user to control and communicate with various appliances, cooking devices, etc., locally or remotely.

The networks 700, 800 may be used to build a meal using limited cooking commands. For example, a given number of food packages may be stored in chilled compartments in one or more of the cooking devices or appliances shown in FIGS. 15 and 16. The number of available cooking chambers (and additional integrated appliances) may be assessed and certain meal choices are determined for the user. A user may select a single “cook” command that then activates all cooking chambers and appliances as necessary to begin cooking all individual food packages needed for the meal. Individual cooking times are taken into account such that all food packages finish cooking at approximately the same time, and are ready all at once. This functionality may rely on the sous-vide cooking devices 10 and other appliances determining food locations and packaged contents based on, for example, RFID or QR tags. If this identifying information is not available on the packaging, for example if a user self-packages the food items, the user may manually insert the data (e.g., via a mobile app or a user interface on one of the sous-vide cooking devices 10), which is then taken into consideration as part of providing the meal choices and selection of a single-cook command.

According to this method, the cooking devices 10A, 10B and other appliances determine the food package locations, determine available cooking chambers, and provide information about the stored food items and location to the hub device (e.g., hub 802, server 606, etc.). The hub receives the food information (e.g., via an RFID tag or manual input), receives cooking chamber information for each of the cooking devices, determines food package contents and type, and associated data about the food, looks up possible meal options based on given food packages and available cooking chambers, sends meal options to the user (e.g., via a mobile app), and suggests and sends alternatives for other meal options given additional future orders.

In response, the user reads the available food package options, reads available meal options provided, and selects either a meal option or a combination of individual options and creates a command to begin cooking. Purchasing aspects related to these methods are that, for future meal options, the user selects purchasing a new “meal” and only receives (and pays for) food packages with contents that the user is missing to complete a particular meal choice.

Thereafter, the hub receives the meal cooking command, determines cook time (and duration) and temperature for all individual packages comprised in the meal, determines a preheat time needed, schedules a start time for all food options, and sends start times and cook commands to corresponding cooking devices and appliances.

The cooking device and related appliances receive the start time and cooking data (e.g., temperature and duration), for each food package, preheats the cooking chamber, auto-loads the food packages into the cooking chambers, and begins the cooking process, and later (via the hub) notifies the user of the process of starting the events, notifies the user of the individual cook start times, notifies the user of current cook temperatures, notifies the user of cook duration, and notifies the user of completion, or some combination thereof

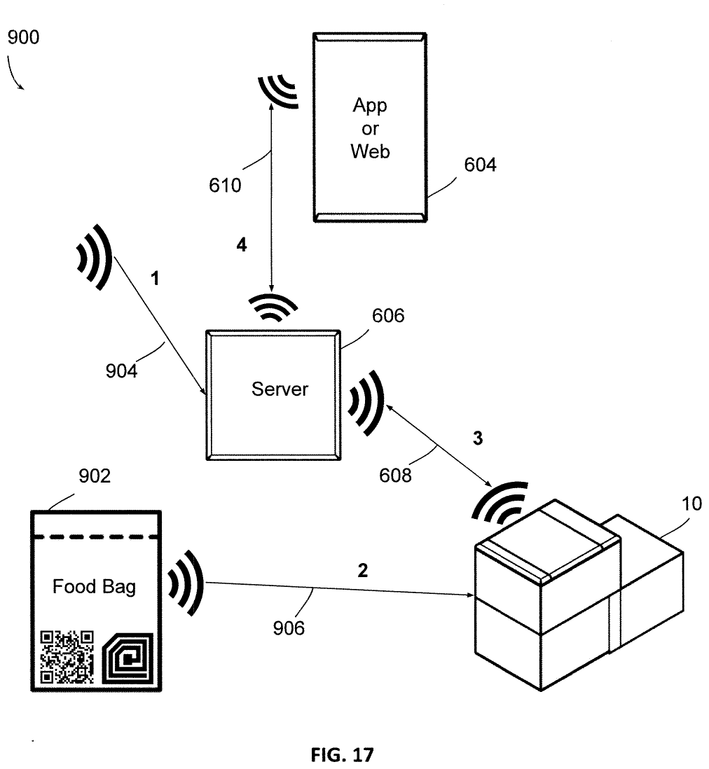

FIG. 17 illustrates package labeling and reading using a network 900. The network 900 provides a central server 606 that receives information about a food item from a manufacturer via a communication link 904 and a step one. A user places a food item 902 in a cooking device 10 and the cooking device 10 scans the food item 902 for information using a link 906. The cooking device 10 determines a location of the food item 902 and transmits information about the food item via a communication link 608 to the server 606. The server sends location and data information to a user via a communication link 610 via, for example, a mobile app or web interface.

The network 900 provides communication and tracking food packaging using, for example, passive RFID tags, QR codes, or the like. A source of the food item (e.g., food packager, butcher shop, grocery market, etc.) can scan and upload information to the server 606, create the stored data which may include, for example, ingredients, type food, type of cut of the food, organic/GMO/antibiotics, wheat, location, packaging date, and expiration date. The system is designed with relatively safe cooking standards and option reusability involved to update package information. The cooking device 10 may scan the food item via, for example, and RFID and/or QR code, and deliver the food package data and determine bay location to the server 606. In a first step, the food package data is received by the server 606. The food item information may be transmitted from the server 606 to the cooking device 10. In other embodiments, the food information may be delivered directly to the cooking device 10 via, for example, using an RFID or QR code reader that is part of the cooking device 10. The cooking device 10 may use this information to determine meal options, ordering quantities, user notifications, and the like.

In a second step, the cooking device 10 determines food package location in various compartments of the cooking device 10 and/or other appliances. This allows the user to simply position the food package in the cooking device 10 or other appliance, and the cooking device 10 can determine which cooking chambers to use, how to automatically create “meal” options and other data such as how long a package of food has been in a particular bay (e.g., related to freshness of the food item). This permits the user to decide simply what they want to eat (e.g., given local food offerings) such that the user does not need to remember or write down what food was placed where in the cooking device or other appliance. The network 900 may then notify the user if the food items are not used and are approaching expiration dates.

According to another method, a single active RFID tag reader may be used for each bay of the cooking device 10. Each bay includes a shielding device or feature to block tags in other bays. A blocking structure may include, for example, metal (e.g., thin aluminum foil), mesh-like metal structures and composite alternatives. Multi-active RFID readers may be used at a location above all of the bays of a unit of a food storage compartment of the cooking device 10, or a single reader may be positioned above every bay. Multi-active RFID readers provide multiple active readers to reach any passive RFID tag positioned in any of the bays. Location is determined via triangulation with the received signal strength indicator (RSSI), time and direction of arrival, or a combination of these methods used to determine the food item in each bay.

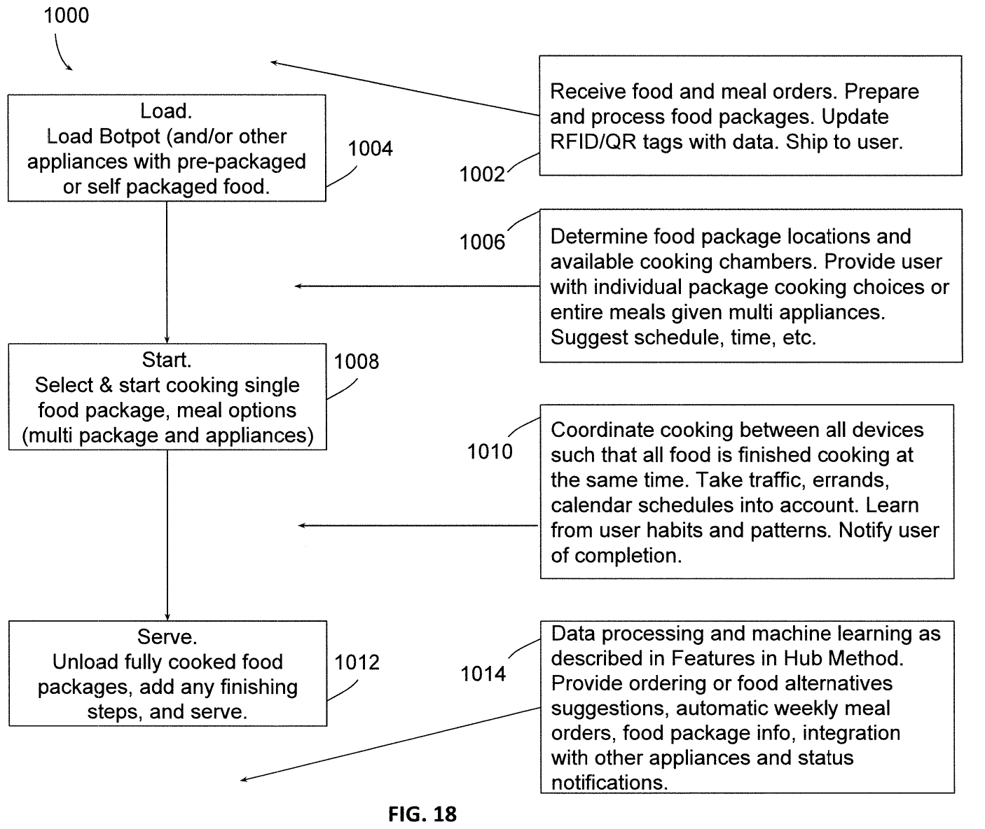

FIGS. 18-26 are flow diagrams illustrating various features and functionality of the cooking devices, networks, and related meal planning and user communication capabilities available via the systems and methods disclosed herein. FIG. 18 illustrates a method 1000 and provides the integration of operation of one or more of the cooking devices disclosed herein and a food/meal shopping/planning program. In a first step 1002, a network receives food and meal orders, prepares and processes food packages, and updates RFID/QR tags with data, followed by shipping the food items to the user. The user loads the cooking device (and/or other appliances) with prepackaged or self-packaged food items in a step 1004. The network in a step 1006 then determines food package locations and available cooking chambers, provides the user with individual package cooking choices or entire meals given multiple appliances available, and suggests schedule, timing, etc. The user then selects and starts cooking single-food package and/or meal options via multiple packages and appliances in a step 1008. The network provides coordinating cooking between all of the devices such that all food is finished cooking at the same time, taking into consideration, for example, traffic, errands, calendar schedules, etc., learning from the user's habits and patterns, and then notifying the user of completion in a step 1010. In a step 1012, the user unloads the fully cooked food packages, adds any finishing preparations to the food, and serves the food. In a step 1014, the network provides data processing and machine learning as described above. The network may provide ordering food alternatives, suggestions, automatic weekly meal orders, food packaging information, integration with other appliances, and status notifications.

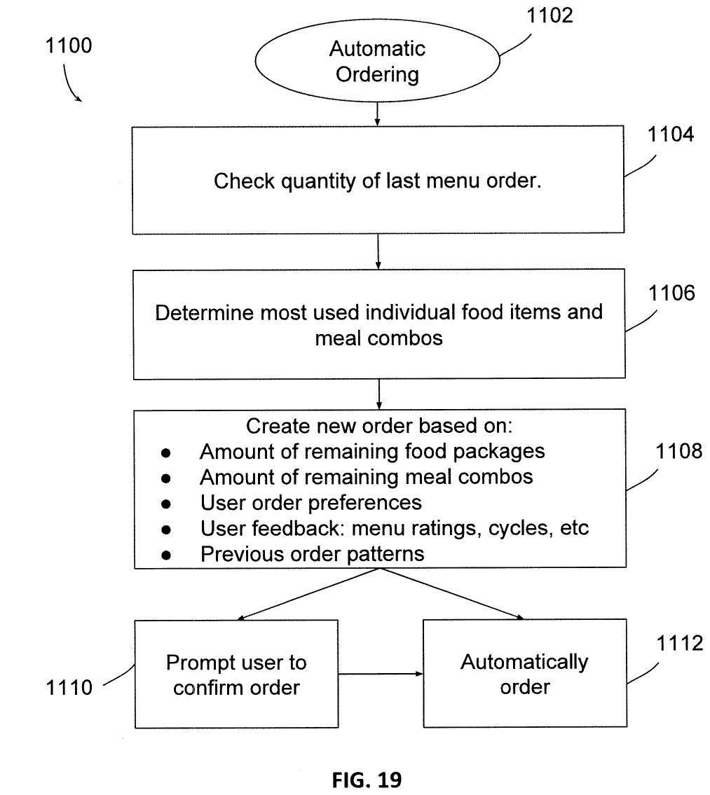

FIG. 19 relates to an automatic ordering system 1100. The automatic ordering begins with a step 1102 by checking the quantity of the last meal ordered in a step 1104. In a step 1106, the method includes determining the most used individual food items and meal combinations. In a step 1108 the method includes creating new food orders based on an amount of remaining food packages, an amount of remaining meal combinations, user order preferences, user feedback (e.g., menu ratings, cycles, etc.), and previous order patterns. In a step 1110, the method may include prompting the user to confirm the order and then automatically ordering in a step 1112. The step 1110 may be bypassed by automatically ordering in the step 1112 after creating the new order in 1108.

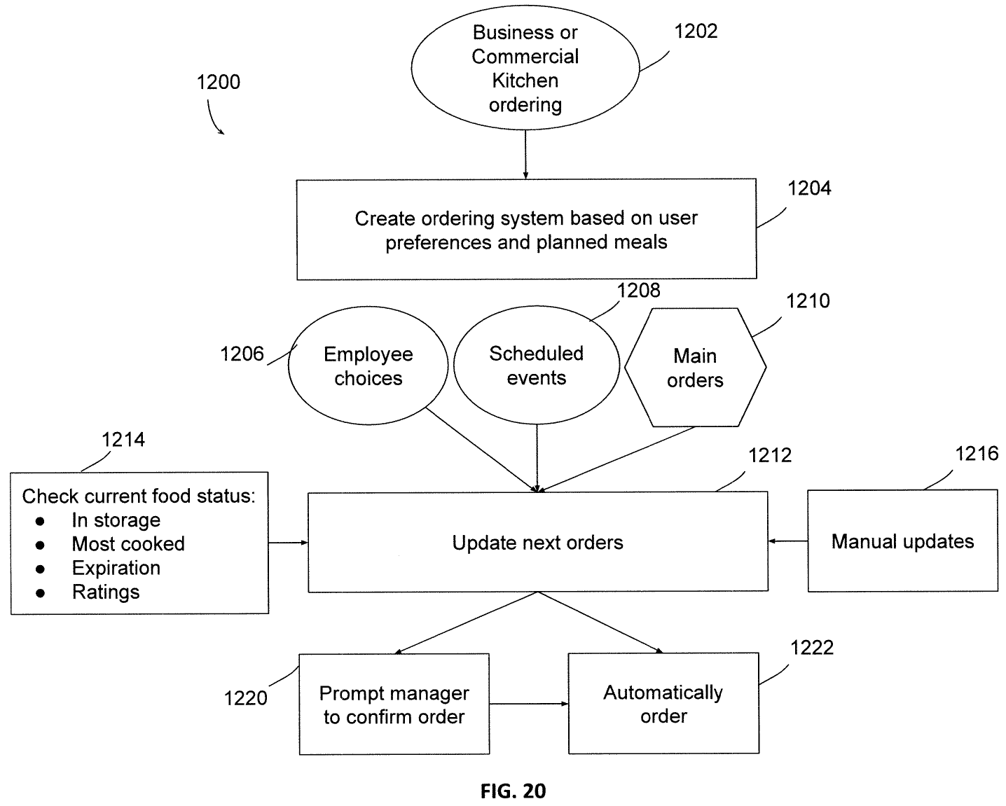

FIG. 20 illustrates a method 1200 related to business or commercial kitchen ordering beginning at step 1202. A step 1204 includes creating an ordering system based on user preferences and planned meals. Updated next orders 1212 are based at least in part on employee choices 1206, scheduled events 1208, main orders 1210, current food status including food in storage, most cooked, expiration dates, and ratings, and manual updates 1216. A manager may be prompted to confirm the order in a step 1220 and then the order is automatically made in step 1222. Alternatively, automatic ordering occurs immediately after updating the next order in step 1212.

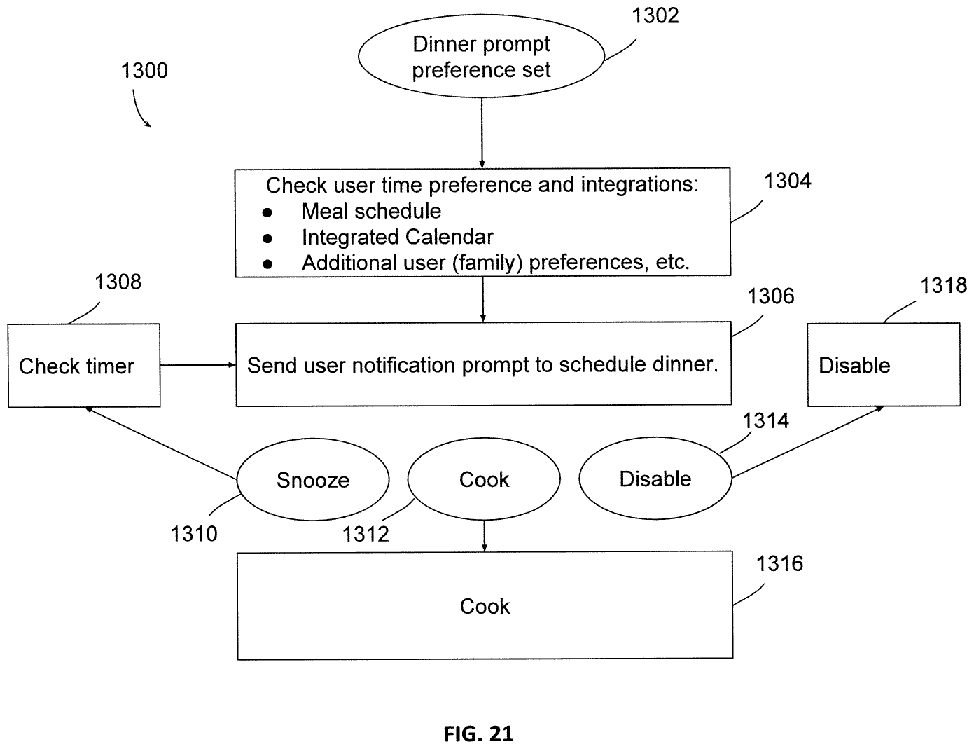

FIG. 21 illustrates a method 1300 related to dinner prompt preference settings 1302. The method includes checking user time preference and integrations in a step 1304 that includes meal schedules, integrated calendaring, and additional user (family) preferences, etc. The step 1306 includes sending a user notification prompt to schedule dinner. Other inputs include a snooze function 1310 that prompts checking a timer 308 to then again send the user notification in step 1306, a cook step 1312 that leads to cooking in step 1316, and a disable prompt 1314 that leads to disabling of the system 1308.

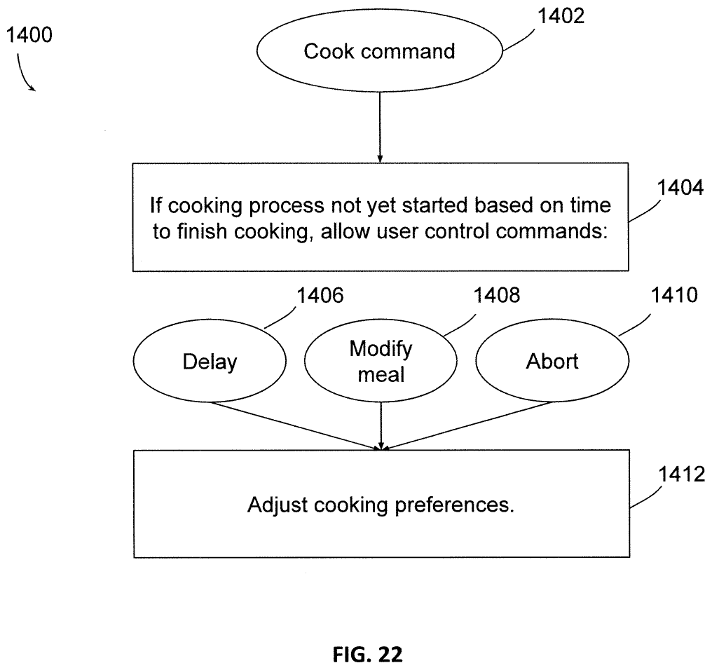

FIG. 22 illustrates a method 1400 related to cooking commands 1402. If according to step 1404, the cooking process is not yet started based on time to finish cooking, the cook command allows the user to control commands such as delay 1406, modify meal 1408, and abort 1410. With these commands, the cooking preferences may be adjusted in step 1412.

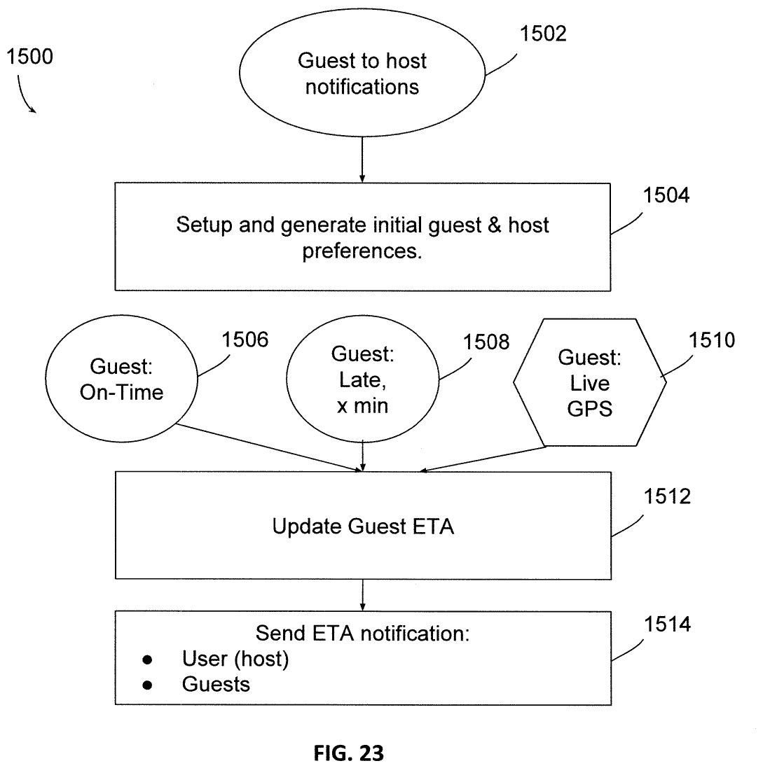

FIG. 23 illustrates a method 1500 related to guests-to-host notifications 1502. A step 1504 relates to set up and generation of initial guest and host preferences. The preferences may include guest on time status 1506, guest late by a certain amount of time 1508, and guest location (e.g., live GPS) in step 1510. The updated guest's estimated time of arrival at 1512 may be generated and an ETA notification may be sent to a user (e.g., host) and/or guest in a step 1514.

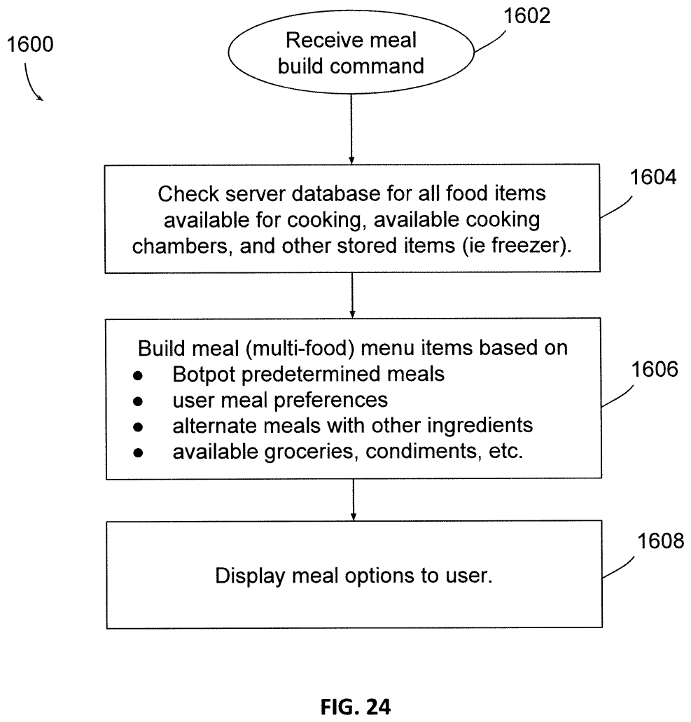

FIG. 24 illustrates a method 1600 related to receiving meal build commands 1602. A step 1604 includes checking server database for all food items available for cooking, available cooking chambers, and all the cooking devices, and other stored items available in other appliances (e.g., stored food in a refrigerator appliance). A step 1606 includes building a meal (e.g., multi-food menu) based on, for example, predetermined meals for a given cooking device, user meal preferences, alternate meals with other ingredients, and available groceries, condiments, etc. A step 1608 includes displaying meal options to the user. The user may then select a particular meal option in a one-step command that initiates cooking the meal.

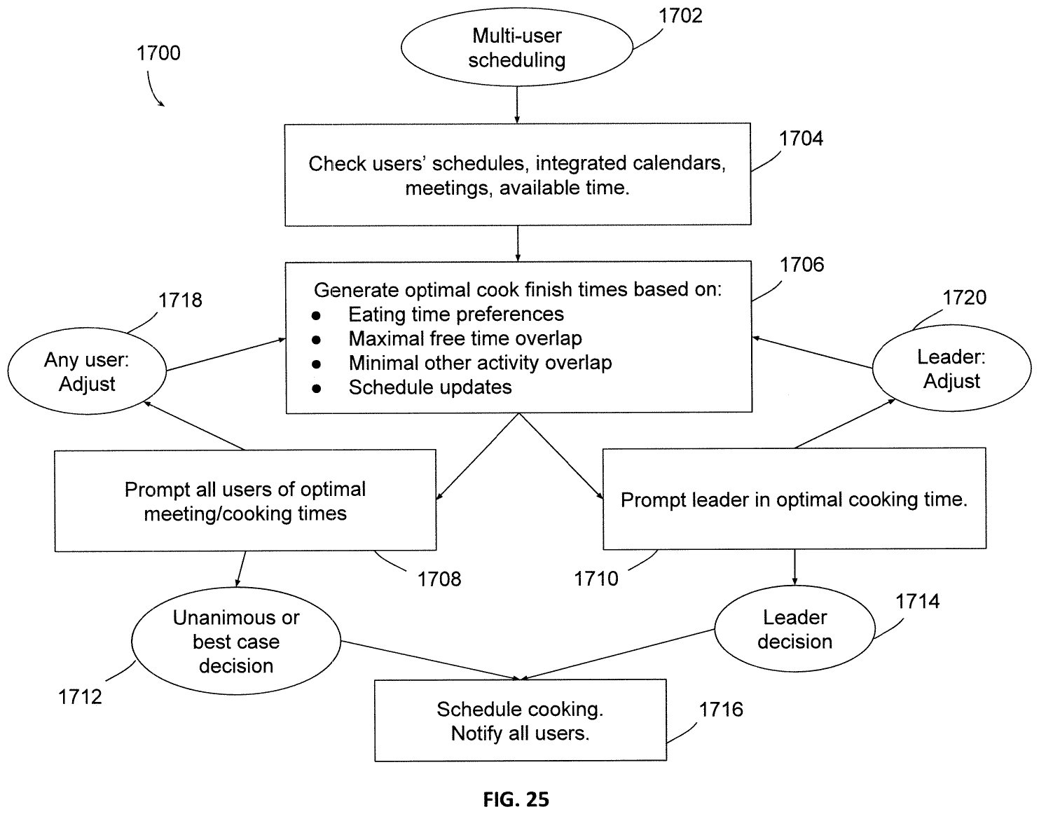

FIG. 25 illustrates the method 1700 relating to multi-user scheduling 1702. The step 1704 includes checking a user's schedules, integrated calendars, meetings, and available times. A step 1706 includes generating optimal cook-finish times based on, for example, eating time preferences, maximum free-time overlap, minimal other-activity overlap, and schedule updates. A step 1708 includes prompting all users of optimal meeting/cooking times. A step 1712 may include unanimous or best case decisions that lead to schedule cooking and notification of users 1716. After prompting the users in step 1708, a step 1718 may include any user adjusting the time. After step 1706, an alternative step 1710 may include prompting a leader of optimal cooking time. This may be followed by step 1714 of a leader decision followed by a scheduled cooking and notification of users 1716. Step 1710 may be followed by a leader adjusting the time in step 1720 which then directs back to the generation of optimal cook finish times in step 1706.

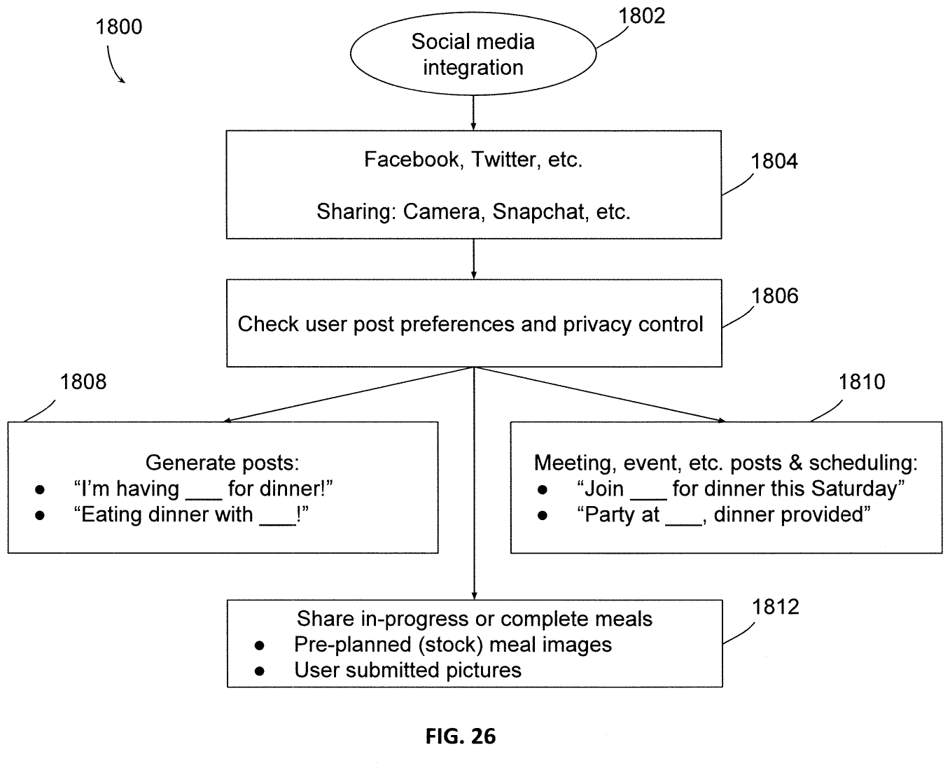

FIG. 26 refers to a method 1800 of social media integration 1802. Step 1804 includes using a social media platform (e.g., Facebook, Twitter, etc.) and/or sharing via camera, snap chat, etc., information related to a meal, preferences, etc. A step 1806 includes checking a user-posted preferences and privacy control. Step 1808 includes generating posts such as, for example, “I'm having ______ over for dinner!”, or “I'm eating dinner with ______!”. Step 1810 includes meeting, event, etc., posts and scheduling such as, for example, “Join _______ for dinner this Saturday,” or “Party at ______, dinner provided.” A step 1812 may include sharing in progress or complete meals such as pre-planned (e.g., stock) meal images, and user-submitted pictures.

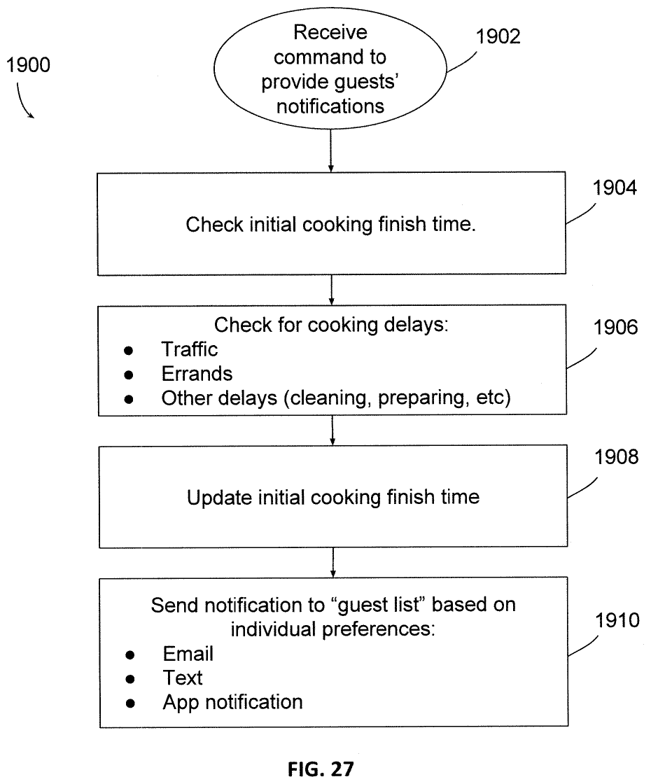

FIG. 27 is a method 1900 related to receiving commands to provide guests with notifications 1902. A step 1902 includes checking initial cooking finish times. Step 1906 includes checking for cooking delays such as traffic, errands, and other delays (e.g., cleaning, preparation, etc.). The initial cooking finish time is updated in a step 1908. A notification is sent to a guest list based on individual preferences in a step 1910 via, for example, email, text, or an app notification.

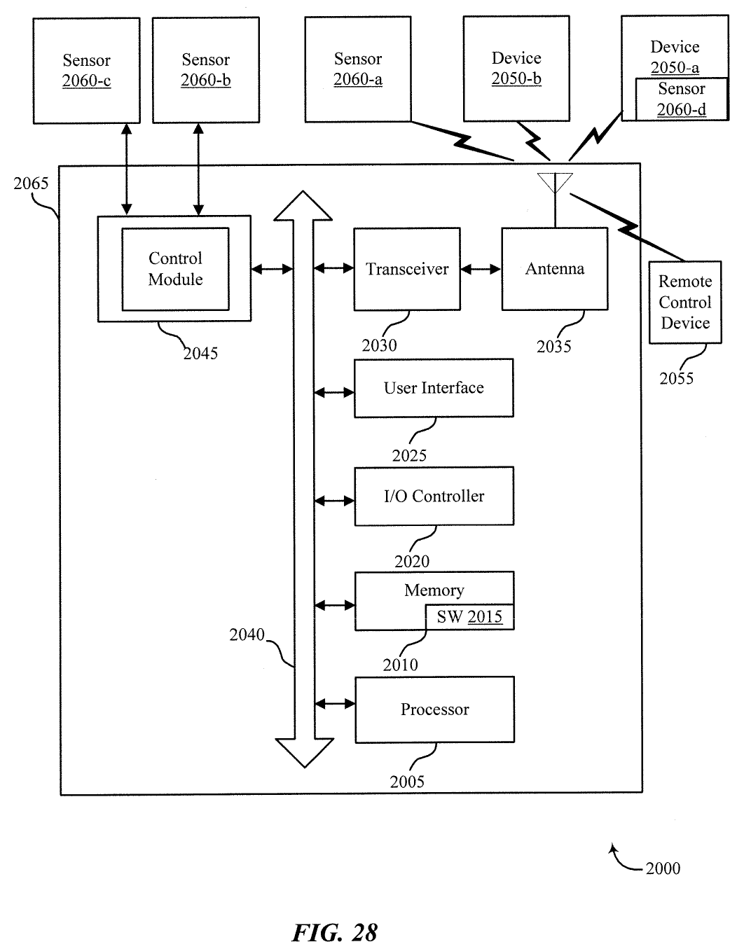

FIG. 28 shows a system 2000 for use with the cooking devices and systems shown and described herein. System 2000 may include a control panel 2065. Control panel 2065 may be equivalent at least in part to a controller, control unit, processor or the like for use with the cooking devices 10, 200, 300, 400, 500, 600, and other cooking devices described above with reference to FIGS. 1-27. Control panel 2065 may include control module 2045. The control module 2045 may provide communications with one or more sensors 2060 directly (e.g., sensors 2060-b, 2060-c) or via other communication components, such as a transceiver 2030 and/or antenna 2035. The sensors 2060 may represent one or more of the sensors in any of the embodiments described above. The control module 2045 may perform or control various operations associated with, for example, the sensors, motors, fans, actuators, pumps, compressors, or other components of the cooking devices and related systems as described above with reference to FIGS. 1-27.

Control panel 2065 may also include a processor module 2005, and memory 2010 (including software/firmware code (SW) 2015), an input/output controller module 2020, a user interface module 2025, a transceiver module 2030, and one or more antennas 2035 each of which may communicate, directly or indirectly, with one another (e.g., via one or more buses 2040). The transceiver module 2030 may communicate bi-directionally, via the one or more antennas 2035, wired links, and/or wireless links, with one or more networks or remote devices. For example, the transceiver module 2030 may communicate bi-directionally with one or more of device 2050-a, 2050-b and/or sensors 2060-a, 2060-d. The device 2050 may be components of the cooking devices and related systems and devices described with reference to FIGS. 1-27, or other devices in communication with such systems and devices. The transceiver 2030 may include a modem to modulate the packets and provide the modulated packets to the one or more antennas 2035 for transmission, and to demodulate packets received from the one or more antennas 2035. In some embodiments (not shown) the transceiver may be communicate bi-directionally with one or more of devices 2050-a, 2050-b, remote control device 2055 (e.g., remote device 29), and/or sensors 2060-a, 2060-d through a hardwired connection without necessarily using antenna 2035. While a control panel or a control device (e.g., 2005) may include a single antenna 2035, the control panel or the control device may also have multiple antennas 2035 capable of concurrently transmitting or receiving multiple wired and/or wireless transmissions. In some embodiments, one element of control panel 2065 (e.g., one or more antennas 2035, transceiver module 2030, etc.) may provide a connection using wireless techniques, including digital cellular telephone connection, Cellular Digital Packet Data (CDPD) connection, digital satellite data connection, and/or another connection.

The signals associated with system 2000 may include wireless communication signals such as radio frequency, electromagnetics, local area network (LAN), wide area network (WAN), virtual private network (VPN), wireless network (using 302.11, for example), 345 MHz, Z-WAVE®, cellular network (using 3G and/or LTE, for example), and/or other signals. The one or more antennas 2035 and/or transceiver module 2030 may include or be related to, but are not limited to, WWAN (GSM, CDMA, and WCDMA), WLAN (including BLUETOOTH® and Wi-Fi), WMAN (WiMAX), antennas for mobile communications, antennas for Wireless Personal Area Network (WPAN) applications (including RFID and UWB). In some embodiments, each antenna 2035 may receive signals or information specific and/or exclusive to itself. In other embodiments, each antenna 2035 may receive signals or information not specific or exclusive to itself

In some embodiments, one or more sensors 2060 (e.g., voltage, inductance, resistance, current, force, temperature, etc.) or devices 2050 may connect to some element of system 2000 via a network using one or more wired and/or wireless connections. In some embodiments, the user interface module 2025 may include an audio device, such as an external speaker system, an external display device such as a display screen, and/or an input device (e.g., remote control device interfaced with the user interface module 2025 directly and/or through I/O controller module 2020).

One or more buses 2040 may allow data communication between one or more elements of control panel 2065 (e.g., processor module 2005, memory 2010, I/O controller module 2020, user interface module 2025, etc.).

The memory 2010 may include random access memory (RAM), read only memory (ROM), flash RAM, and/or other types. The memory 2010 may store computer-readable, computer-executable software/firmware code 2015 including instructions that, when executed, cause the processor module 2005 to perform various functions described in this disclosure (e.g., initiating an adjustment of a lighting system, etc.). Alternatively, the software/firmware code 2015 may not be directly executable by the processor module 2005 but may cause a computer (e.g., when compiled and executed) to perform functions described herein. Alternatively, the computer-readable, computer-executable software/firmware code 2015 may not be directly executable by the processor module 2005 but may be configured to cause a computer (e.g., when compiled and executed) to perform functions described herein. The processor module 2005 may include an intelligent hardware device, e.g., a central processing unit (CPU), a microcontroller, an application-specific integrated circuit (ASIC), etc.

In some embodiments, the memory 2010 can contain, among other things, the Basic Input-Output system (BIOS) which may control basic hardware and/or software operation such as the interaction with peripheral components or devices. For example, the control module 2045, and other modules and operational components of the control panel 2065 used to implement the present systems and methods may be stored within the system memory 2010. Applications resident with system 2000 are generally stored on and accessed via a non-transitory computer readable medium, such as a solid state storage drive or other storage medium. Additionally, applications can be in the form of electronic signals modulated in accordance with the application and data communication technology when accessed via a network interface (e.g., transceiver module 2030, one or more antennas 2035, etc.).

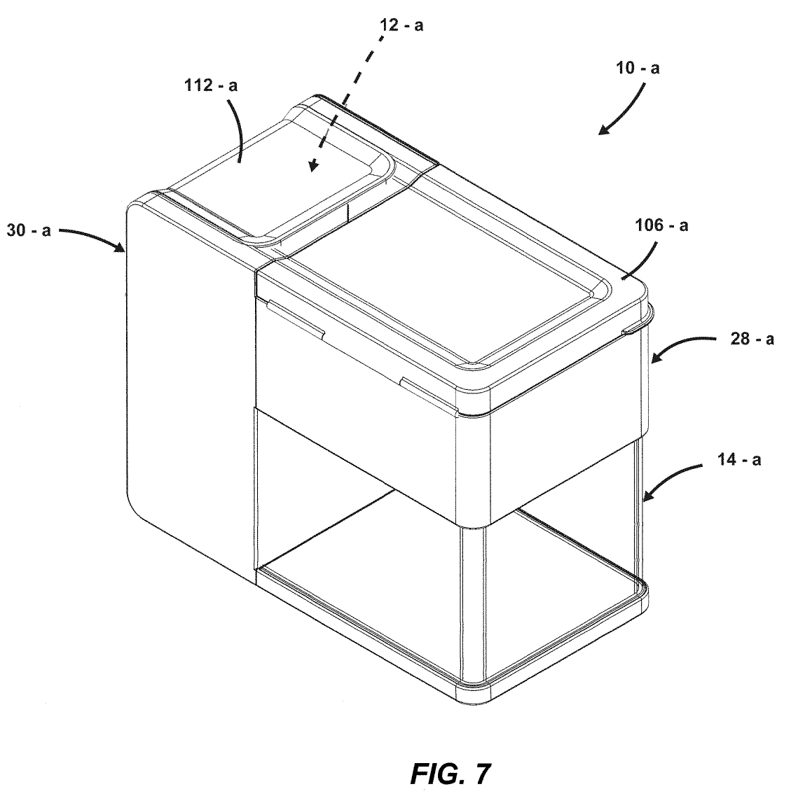

Many other devices and/or subsystems may be connected to one or may be included as one or more elements of system 2000. In some embodiments, all of the elements shown in FIG. 7 need not be present to practice the present systems and methods. The devices and subsystems can be interconnected in different ways from that shown in FIG. 28. In some embodiments, an aspect of some operation of a system, such as that shown in FIG. 28, may be readily known in the art and are not discussed in detail in this application. Code to implement the present disclosure can be stored in a non-transitory computer-readable medium such as one or more of system memory 2010 or other memory. The operating system provided on I/O controller module 2020 may be iOS®, ANDROID®, MS-DOS®, MS-WINDOWS®, OS/2®, UNIX®, LINUX®, or another known operating system.

The transceiver module 2030 may include a modem configured to modulate the packets and provide the modulated packets to the antennas 2035 for transmission and/or to demodulate packets received from the antennas 2035. While the control panel or control device (e.g., 2005) may include a single antenna 2035, the control panel or control device (e.g., 2005) may have multiple antennas 2035 capable of concurrently transmitting and/or receiving multiple wireless transmissions.

The detailed description set forth above in connection with the appended drawings describes examples and does not represent the only instances that may be implemented or that are within the scope of the claims. The terms “example” and “exemplary,” when used in this description, mean “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and apparatuses are shown in block diagram form in order to avoid obscuring the concepts of the described examples.

As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

In addition, any disclosure of components contained within other components or separate from other components should be considered exemplary because multiple other architectures may potentially be implemented to achieve the same functionality, including incorporating all, most, and/or some elements as part of one or more unitary structures and/or separate structures.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed.

The process parameters, actions, and steps described and/or illustrated in this disclosure are given by way of example only and can be varied as desired. For example, while the steps illustrated and/or described may be shown or discussed in a particular order, these steps do not necessarily need to be performed in the order illustrated or discussed. The various exemplary methods described and/or illustrated here may also omit one or more of the steps described or illustrated here or include additional steps in addition to those disclosed.

This description, for purposes of explanation, has been described with reference to specific embodiments. The illustrative discussions above, however, are not intended to be exhaustive or limit the present systems and methods to the precise forms discussed. Many modifications and variations are possible in view of the above teachings. The embodiments were chosen and described in order to explain the principles of the present systems and methods and their practical applications, to enable others skilled in the art to utilize the present systems, apparatus, and methods and various embodiments with various modifications as may be suited to the particular use contemplated.

1. A cooking device, comprising:
a food storage compartment configured to retain at least one food item;
a cooking tank configured to retain a volume of liquid;
at least one door interposed between the food storage compartment and the cooking tank;
an actuator operable to control movement of the at least one door between open and closed positions, wherein the at least one food item automatically dispenses from the food storage compartment to the cooking tank when the at least door is in the open position;
a programmable controller operable to control operation of the actuator based on one or more user inputs.

2. (canceled)

3. The cooking device of claim 1, wherein the food storage compartment is movable from a first position vertically above the cooking tank to a second position moved laterally relative to the cooking tank.

4. The cooking device of claim 1, wherein the food storage compartment is refrigerated.

5. (canceled)

6. (canceled)

7. The cooking device of claim 1, further comprising a refrigerator system configured to circulate cooled fluids to the food storage compartment

8. The cooking device of claim 1, wherein the food storage compartment includes at least two food chambers configured to retain separate food items.

9. The cooking device of claim 8, wherein the at least one door includes a separate door for each of the at least two food chambers.

10. The cooking device of claim 1, wherein the at least one door includes first and second doors.

11. The cooking device of claim 1, wherein the controller has remote control capabilities.

12. The cooking device of claim 1, wherein the controller operates to control a temperature of the volume of liquid and a temperature inside the food storage compartment.

13. The cooking device of claim 1, further comprising a plurality of temperature sensors operable to sense a temperature of the volume of liquid and a temperature inside the food storage compartment.

14. (canceled)

15. The cooking device of claim 1, further comprising a scanner operable to detect the at least one food item inside the food storage compartment.

16. The cooking device of claim 1, further comprising a heater system having a heater and at least one pump configured to transfer the volume of liquid between the heater and the cooking tank.

17. The cooking device of claim 1, wherein the refrigerator system comprises a heat pump and at least one fan.

18. The cooking device of claim 1, further comprising a secondary tank, where the food storage compartment includes a plurality of compartments each sized to hold a separate food item, the at least one door includes a plurality of doors associated with the plurality of compartments, and the plurality of doors are operable by the actuator to dispense food items from the plurality of compartments to at least one of the cooking tank and the secondary tank.

19. (canceled)

20. (canceled)

21. The cooking device of claim 1, wherein the at least one door is biased into the closed position by a biasing force, the actuator operates to move the at least one door from the closed position to the open position against the biasing force, and the at least one door moves from the open position to the closed position by releasing the actuator.

22. The cooking device of claim 1, further comprising a housing, wherein the food storage compartment, cooking tank, at least one door, actuator, and programmable controller are positioned within the housing and movable as a single unit.

23. (canceled)

24. The cooking device of claim 1, wherein the food storage compartment includes an interior housing and an exterior housing, the interior housing including at least one bay sized to retain the food item, and a space provided between the interior and exterior housings is filled with an insulating material.

25. The cooking device of claim 7, wherein the refrigerator system comprises a compressed gas, Peltier style refrigeration device.

26. (canceled)

27. A method of cooking a food article, comprising:
providing a cooking device comprising a food storage compartment, a cooking tank, at least one door interposed between the food storage compartment and the cooking tank, an actuator, and a heater assembly;
operating the heater assembly to control a temperature of liquid stored in the cooking tank;
operating the actuator to control movement of the at least one door between a closed position and an open position to dispense a food item from the food storage compartment to the cooking tank.

28. (canceled)

29. The method of claim 27, wherein the cooking device further comprises a refrigerator system, the method further comprising operating the refrigerator system to control a temperature inside the food storage compartment.

30. (canceled)

31. (canceled)
